(19) United States
(12) Patent Application Publication
(10) Pub. No.: US 2018/0355682 A1
(43) Pub. Date: Dec. 13, 2018

(54) Oil Field Services Apparatus and Methods

(71) Applicant: Schlumberger Technology Corporation, Sugar Land, TX (US)

(72) Inventors: Jean-Louis Pessin, Roissy-en-France (FR); Stephane Georget, Abbeville (FR); Maxime Bouffe, Roissy-en-France (FR); Pierre-Yves Corre, Abbeville (FR)

(21) Appl. No.: 16/006,031

(22) Filed: Jun. 12, 2018

(30) Foreign Application Priority Data
Jun. 13, 2017 (EP) 17290076.3

(51) Int. Cl. E21B 19/00; E21B 19/084; E21B 17/00; H02G 11/02; H01B 7/00; H01B 7/02; G02B 6/44; B66D 1/12

(52) U.S. Cl. CPC E21B 19/008; E21B 19/084; E21B 17/003; H02G 11/02; E21B 47/12; H01B 7/0275; G02B 6/4413; G02B 6/4415; B66D 1/12; H01B 7/0009

(57) ABSTRACT

Oil field services apparatus and method. The apparatus comprises a conveyance system operable for lowering and retrieving a downhole tool in and out of a wellbore. The conveyance system comprises a drum operable for rotating and receiving a line connectable with the downhole tool, a motor-generator mechanically connected with the drum, and an energy storage electrically connected with the motor-generator. The motor-generator may be operable for receiving electrical energy to impart torque to the drum and receiving torque from the drum to generate electrical energy. The energy storage may be operable for storing electrical energy received from the motor-generator.

### BACKGROUND OF THE DISCLOSURE

Wells are generally drilled into a land surface or ocean bed to recover natural deposits of oil and gas, as well as other natural resources that are trapped in geological formations in the Earth's crust. Wellbores may be drilled along a trajectory to reach one or more subterranean rock formations containing such natural resources. Information about the subterranean formations and formation fluid, such as measurements of the formation pressure, formation permeability, and recovery of formation fluid samples, may be utilized to increase well production and to predict the economic value, the production capacity, and the production lifetime of the subterranean formation.

Various well deployment wires or cables (e.g., slicklines, wirelines, multilines, and the like), collectively referred to hereinafter as lines, may be utilized to convey downhole tools to reach the oil and gas deposits and to perform various well treatment and/or well intervention operations within the wellbores. Lines have the ability to pass through completion or other downhole tubulars and to deploy a wide array of tools and technologies, such as may be utilized for opening and closing valves, placing packings or other elements, and perforating walls of the downhole tubulars. Lines may also transmit electrical energy and information between a wellsite surface and the downhole tools. A typical downhole deployment system includes a line, a reel for storing the line, an apparatus for conveying the line into and out of the wellbore (e.g., generally a winch), and surface well control apparatus at a wellhead.

In working with deeper and more complex wellbores, it becomes more likely that downhole tools, tool strings, and/or other downhole apparatus may include numerous testing, navigation, and/or communication tools, resulting in increasingly longer tools that consume increasingly larger quantities of electrical power to drive or otherwise energize various internal components of such tools. The length and weight of downhole tools is often dependent on what function they perform, where additional functions typically imply additional length and, thus, weight. As more and more sophisticated functions are performed downhole, downhole tools have grown in weight to a point where downhole deployment and conveyance operations impart excessive stresses and strains to the lines, resulting in excessive wear and tear and, thus, diminished operational life.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of an example implementation of an apparatus related to one or more aspects of the present disclosure.

FIG. 3 is a schematic view of at least a portion of an example implementation of apparatus according to one or more aspects of the present disclosure.

FIG. 4 is a schematic view of another example implementation of the apparatus shown in FIG. 3 according to one or more aspects of the present disclosure.

FIG. 5 is a schematic view of another example implementation of the apparatus shown in FIG. 3 according to one or more aspects of the present disclosure.

FIG. 6 is a schematic view of another example implementation of the apparatus shown in FIG. 3 according to one or more aspects of the present disclosure.

FIG. 7 is a perspective view of at least a portion of an example implementation of apparatus according to one or more aspects of the present disclosure.

FIG. 8 is a schematic view of at least a portion of an example implementation of apparatus according to one or more aspects of the present disclosure.

FIG. 9 is an enlarged perspective view of a portion of an example implementation of the apparatus shown in FIG. 8 according to one or more aspects of the present disclosure.

FIG. 10 is a schematic view of at least a portion of an example implementation of apparatus according to one or more aspects of the present disclosure.

FIG. 11 is a schematic sectional axial view of at least a portion of an example implementation of apparatus according to one or more aspects of the present disclosure.

FIG. 12 is a sectional side view of a portion of the apparatus shown in FIG. 11 according to one or more aspects of the present disclosure.

FIG. 13 is a schematic sectional axial view of at least a portion of an example implementation of apparatus according to one or more aspects of the present disclosure.

FIG. 14 is a sectional side view of a portion of the apparatus shown in FIG. 13 according to one or more aspects of the present disclosure.

FIG. 15 is a schematic sectional axial view of at least a portion of an example implementation of apparatus according to one or more aspects of the present disclosure.

FIG. 16 is a sectional side view of a portion of the apparatus shown in FIG. 15 according to one or more aspects of the present disclosure.

FIG. 17 is a schematic sectional axial view of at least a portion of an example implementation of apparatus according to one or more aspects of the present disclosure.

FIG. 18 is a sectional side view of a portion of the apparatus shown in FIG. 17 according to one or more aspects of the present disclosure.

FIG. 19 is a schematic sectional axial view of at least a portion of an example implementation of apparatus according to one or more aspects of the present disclosure.

FIG. 20 is a sectional side view of a portion of the apparatus shown in FIG. 19 according to one or more aspects of the present disclosure.

FIG. 21 is a schematic view of at least a portion of an example implementation of apparatus according to one or more aspects of the present disclosure.

FIG. 22 is a schematic view of at least a portion of an example implementation of apparatus according to one or more aspects of the present disclosure.

FIG. 23 is a schematic view of at least a portion of an example implementation of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

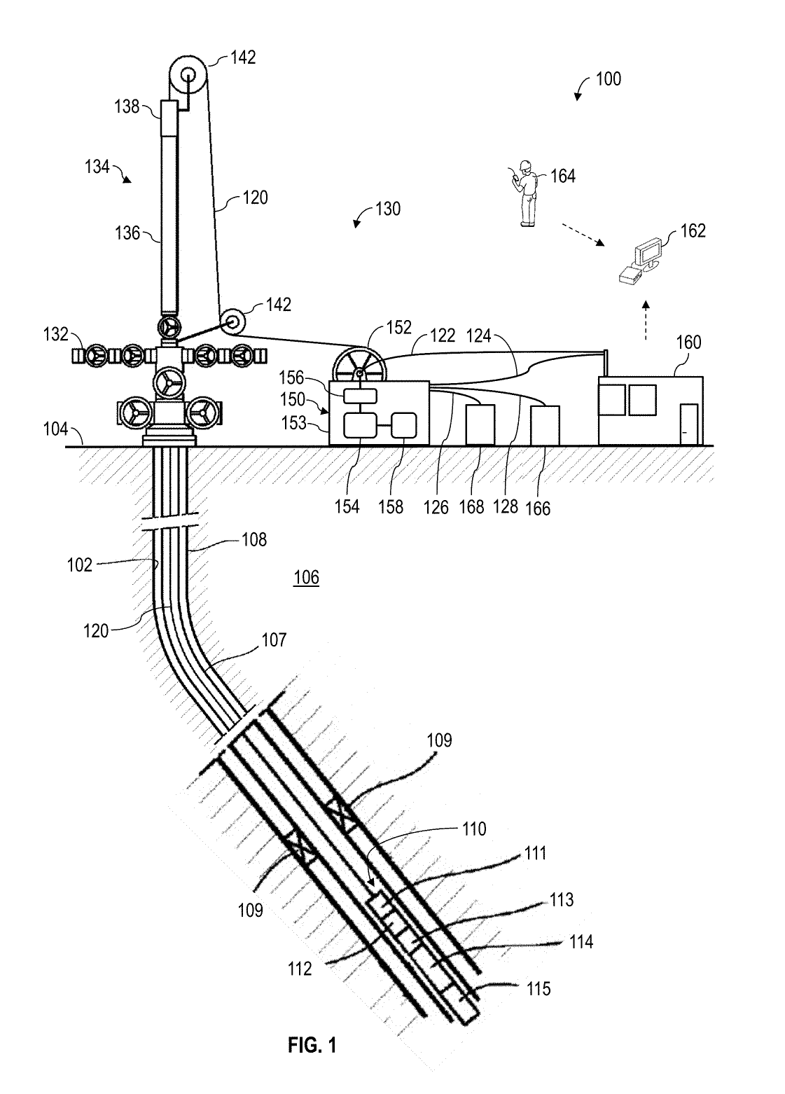

FIG. 1 is a schematic view of at least a portion of an example implementation of a wellsite system 100 according to one or more aspects of the present disclosure. The wellsite system 100 represents an example environment in which one or more aspects of the present disclosure may be implemented. It is also noted that although the wellsite system 100 is depicted as an onshore implementation, it is understood that the aspects described below are also generally applicable to offshore implementations. The wellsite system 100 is depicted in relation to a wellbore 102 (i.e., a cavity) formed by rotary and/or directional drilling and extending from a wellsite surface 104 into a subterranean formation 106. The wellsite system 100 may be utilized to recover natural deposits of oil, gas, and/or other materials that are trapped in the subterranean formation 106 via the wellbore 102.

The wellbore 102 may be a cased-hole implementation comprising an outer tubular pipe, referred to as casing 108, secured by cement (not shown). However, one or more aspects of the present disclosure are also applicable to and/or readily adaptable for utilizing in open-hole implementations lacking the casing 108 and cement. The wellbore 102 may also contain one or more inner tubular pipes, referred to as production tubing 107, having a smaller diameter and mounted within the casing 108. The production tubing 107 may be wedged inside the casing 108 by packings 109. However, it is to be understood that the production tubing 107 may not be utilized.

The wellbore 102 may be capped by a plurality of well control devices, which may include a blowout preventer (BOP) stack and one or more annular fluid control device, such as an annular preventer. The well control devices may be mounted on top of a wellhead 132, which may include a plurality of selective access valves operable to close selected tubulars or pipes, such as the production tubing 107 and/or casing 108, extending within the wellbore 102.

The wellsite system 100 includes surface equipment 130 located at the wellsite surface 104 and a downhole intervention and sensor assembly, referred to as a tool string 110, suspended within the casing 108 or the production tubing 107 via a line 120 operably coupled with one or more pieces of the surface equipment 130. The tool string 110 may be deployed into or retrieved from the wellbore 102 through a sealing and alignment assembly 134 mounted on the wellhead 132 and operable to seal the line 120 during deployment, conveyance, intervention, and other wellsite operations. The sealing and alignment assembly 134 may comprise a lock chamber 136 (e.g., a lubricator, an airlock, a riser) mounted on the wellhead 132, a stuffing box 138 operable to seal around the line 120 at top of the lock chamber 136, and return pulleys 142 operable to guide the line 120 between the stuffing box 138 and the surface equipment 130 connected with the line. The stuffing box 138 may be operable to seal around an outer surface of the line 120, for example via annular packings applied around the surface of the line 120 and/or by injecting a fluid between the outer surface of the line 120 and an inner wall of the stuffing box 138.

The line 120 may be or comprise a wire, a cable, a wireline, a slickline, a multiline, an e-line, and/or other conveyance means. The line 120 may comprise one or more metal support wires or cables configured to support the weight of the downhole tool string 110. The line 120 may also comprise one or more electrical and/or optical conductors operable to transmit electrical energy (i.e., electrical power) and electrical and/or optical signals (e.g., information, data) therethrough, such as may permit transmission electrical energy, data, and/or control signals between the tool string 110 and one or more of the surface equipment 130.

FIG. 1 further shows the wellsite system 100 comprising a winch conveyance system 150 (i.e., a winch unit) according to one or more aspects of the present disclosure. The winch conveyance system 150 may be operably connected with the line 120 and operable to wind and unwind the line 120 and, thus, apply an adjustable tensile force to the tool string 110 disposed within the wellbore 102 to selectively convey the tool string 110 along the wellbore 102. The winch conveyance system 150 may comprise a line reel or drum 152 configured to store thereon a wound length of the line 120. The drum 152 may be rotatably connected with a stationary base or frame 153 of the winch conveyance system 150, such that the drum 152 may be rotated to wind and unwind the line 120. The drum 152 may be selectively rotated by an electrical or hydraulic motor 154. A gear box or transmission 156 may be mechanically or otherwise operatively connected between the motor 154 and the drum 152, such as may facilitate control of rotational speed and torque applied to the drum 152. When the motor 154 is implemented as a hydraulic motor, a pump may be driven by an engine or an electric motor to supply hydraulic energy. The hydraulics system may provide variable speed commands. When the motor 154 is implemented as an electrical motor, the motor 154 may be electrically connected with an electrical motor controller 158 (e.g., a variable frequency drive, a chopper) operable to control the speed and/or torque of the motor 154, such as by controlling the frequency and/or the amplitude of the electrical energy (i.e., electrical power) supplied to the motor 154.

Electrical energy may be supplied to the winch conveyance system 150 from one or more of an electrical generator unit 166, an electrical energy storage unit 168, and an external electrical energy source (not shown) electrically connected with the winch conveyance system 150. The electrical energy storage 168 may be or comprise one or more rechargeable batteries, ultra-capacitors, fuel cells, and/or other means operable to store and supply direct current (DC) electrical energy. The electrical energy storage 168 may be disposed at the wellsite surface 104 and be electrically connected with the winch conveyance system 150 via an electrical conduit 126. The generator unit 166 may be or comprise an engine-generator set (i.e., gen-set), such as a gas turbine generator or an internal combustion engine generator. The generator unit 166 may be disposed at the wellsite surface 104 and be electrically connected with the winch conveyance system 150 via an electrical conduit 128. The surface equipment 130, including the winch conveyance system 150, may also or instead be electrically connected with an electrical energy distribution center (not shown) operable to receive and distribute electrical energy supplied to the wellsite system 100 from external sources, such as an electrical power grid, an electrical windmill, and electrical solar panels. Although electrical energy may be provided to the winch conveyance system 150 from various sources, the electrical energy storage 168 may be utilized as a source of electrical energy for supplying energy to the winch. Alternatively, the electrical energy storage 168 may not be a source of energy for the winch conveyance system 150, but for additional wellsite equipment (i.e., wellsite elements), such as a slurry, mud, and/or other fluid pumps.

In addition to winding and unwinding the line 120 to run (i.e., lower or convey downhole) and retrieve (i.e., pull or convey uphole) the downhole tool string 110, the winch conveyance system 150 may be further operable to capture mechanical energy released during tool string running operations and store the mechanical energy as electrical energy in the electrical energy storage 168 and selectively release the stored electrical energy, such as for supplying electrical energy to the winch conveyance system 150 during subsequent tool string retrieval or pulling operations. To capture the mechanical energy in the form of electrical energy, the motor 154 may be or comprise a motor-generator operable as a motor and a generator and the motor controller 158 may be or comprise a bi-directional converter or controller (e.g., a driver) operable to condition and transfer the electrical energy in both directions between the motor-generator 154 and the electrical energy storage 168. For example, when the tool string 110 is ran into the wellbore 102, the motor-generator 154 may be entrained by the weight of the line 120 and the tool string 110 and operate as a generator, delivering electrical energy to the controller 158. During running operations, the motor-generator 154 may receive torque from the rotatable drum 152 via the transmission 156 to generate the electrical energy, and the controller 158 may direct the generated electrical energy to the electrical energy storage 168 to be stored. Thereafter, the electrical energy storage 168 may supply the controller 158 with electrical energy to operate the motor-generator 154 to retrieve the tool string 110 out of the wellbore 102. However, the controller 158 may also be operable only to direct the generated electrical energy to the electrical energy storage 168, while another (e.g., external) source of energy supplies electrical energy to the motor-generator 154.

The wellsite system 100 may also comprise the control center 160 from which various portions of the wellsite system 100 may be monitored and controlled. The control center 160 may be located at the wellsite surface 104 or on a structure located at the wellsite surface 104. The control center 160 may contain or comprise a processing device 162 (e.g., a computer) operable to provide control to one or more portions of the wellsite system 100 and/or operable to monitor operations of one or more portions of the wellsite system 100, including the winch conveyance system 150 and tool string 110. The processing device 162 may include an input device for receiving commands from a human operator 164 and an output device for displaying information to the human operator 164. The processing device 162 may store executable programs and/or instructions, including for implementing one or more aspects of the wellsite operations described herein.

The control center 160 and/or processing device 162 may be communicatively connected with various equipment of the wellsite system 100 described herein, such as may permit the processing device 162 to receive signals from and transmit signals to such equipment to perform various wellsite operations described herein. The control center 160 may be communicatively and/or electrically connected with the winch conveyance system 150 via a conduit 124. The control center 160 may be communicatively and/or electrically connected with the tool string 110 via the line 120 and a conduit 122 connected with the line 120 via a rotatable joint or coupling (e.g., a collector) (not shown) carried by the drum 152. The line 120 and conduits 122, 124 may comprise one or more electrical and/or optical conductors operable to transmit electrical energy and electrical and/or optical signals between the control center 160, the winch conveyance system 150, and the tool string 110. However, it is to be understood that communication between the control center 160, the processing device 162, the winch conveyance system 150, and other wellsite equipment may be via other conduits and/or wireless communication means. For clarity and ease of understanding, such communication means are not depicted, and a person having ordinary skill in the art will appreciate that such communication means are within the scope of the present disclosure.

The tool string 110 may comprise a plurality of downhole tools 111-115 mechanically, electrically, and/or communicatively coupled together via corresponding mechanical, electrical, and/or optical couplings and corresponding electrical and/or optical conductors extending through one or more of the tools 111-115. Such electrical and/or optical couplings and conductors may permit one or more of the tools 111-115 to be communicatively connected with the control center 160 via the electrical and/or optical conductors of the line 120 and conduit 122. For example, the line 120 and conduit 122 may conduct electrical energy, data, and/or control signals between the control center 160 and one or more of the tools 111-115.

The downhole tools 111-115 may each be or comprise at least a portion of one or more downhole apparatus, subs, modules, and/or other tools operable in slickline, wireline, completion, production, and/or other implementations. For example, the tools 111-115 may each be or comprise at least a portion of a connection head, an acoustic tool, a density tool, an electromagnetic (EM) tool, a formation evaluation or logging tool, a magnetic resonance tool, a neutron tool, a nuclear tool, a photoelectric factor tool, a porosity tool, a reservoir characterization tool, a resistivity tool, a seismic tool, a surveying tool, a tension measuring tool, a directional tool, a gravity tool, an orientation tool, a depth correlation tool, a centralizer, an actuator, a valve shifting tool, a tractor, an impact or jarring tool, a release tool, a perforating tool, a cutting tool, a plug setting tool, and a plug.

In an example implementation of the tool string 110, the downhole tool 111 may be or comprise a cable head operable to connect the line 120 with the tool string 110. The tool 112 may be or comprise a control tool, such as may be operable to store and/or receive control signals from the control center 160 for controlling one or more tools 111-115 of the tool string 110. The control tool may further comprise a downhole transmitter/receiver (i.e., a telemetry device), such as may be operable to receive electrical and/or optical control signals transmitted from the control center 160 via the line 120 and conduit 122 and to transmit a confirmation, tool status, and/or sensor signals to the control center 160 via the line 120 and conduit 122. The control tool may be operable to store and/or communicate with the control center 160 signals or information generated by one or more sensors or instruments of the tools 111-115.

The tool 113 may be or comprise a wellbore positioning tool. For example, the wellbore positioning tool may comprise inclination sensors and/or other orientation sensors, such as one or more accelerometers, magnetometers, gyroscopic sensors (e.g., micro-electro-mechanical system (MEMS) gyros), and/or other sensors for utilization in determining the orientation of the tool string 110 relative to the wellbore 102. The wellbore positioning tool may further comprise a depth correlation tool, such as a casing collar locator (CCL) for detecting ends of casing collars by sensing a magnetic irregularity caused by the relatively high mass of an end of a collar of the casing 108. The correlation tool may also or instead be or comprise a gamma ray (GR) tool that may be utilized for depth correlation. The CCL and/or GR tools may transmit signals in real-time to the control center 160 via the line 120. The CCL and/or GR signals may be utilized to determine the position of the tool string 110 or portions thereof, such as with respect to known casing collar numbers and/or positions within the wellbore 102. Therefore, the CCL and/or GR tools may be utilized to detect and/or log the location of the tool string 110 within the wellbore 102, such as during deployment within the wellbore 102 or other downhole operations.

The tool 114 be or comprise a jarring or impact tool operable to impart an impact or force to a stuck portion of the tool string 110 to help free the stuck portion of the tool string 110. The impact tool within the scope of the present disclosure may store energy for performing impact or jarring operations in the line 120 operable to convey a tool string 110 into the wellbore 102. When a portion of the tool string 110 gets stuck or jammed within the wellbore 102, the line 120 may be pulled in the uphole direction to build up tension and, thus, store energy in the stretched line 120 to be released by the impact tool at a predetermined time or situation.

The tool 114 may also or instead be or comprise a release tool coupling uphole and downhole portions of the tool string 110 and selectively operable to release the uphole and downhole portions from each other. The release tool may permit a portion of the tool string 110 connected downhole (i.e., below) the release tool to be left in the wellbore 102 while a portion of the tool string 110 located uphole (i.e., above) the release tool may be retrieved to the wellsite surface 104. Accordingly, if a portion of the tool string 110 is stuck within the wellbore 102 and cannot be freed, such as via the impact tool, the release tool located uphole from the stuck portion of the tool string 110 may be operated to release the free portion of the tool string 110 such that it may be retrieved to the wellsite surface 104.

The tool 115 may be or comprise one or more downhole apparatus listed above, such as may be operable to perform intervention, measuring, and/or other downhole operations. For example, the tool 115 may be a mechanical actuator operable to perform downhole operations, such as opening and closing downhole valves and placing packers and other members. The tool 115 may include sensors for detecting physical parameters such as the temperature, pressure, flow rate, depth, and status of the downhole valves. The tool 115 may include an exploration device, such as a video camera. The tool 115 may include a means for inspecting and/or cleaning the casing 108 or the production tubing 107. The tool 115 may be or comprise cutting or perforating tool, such as may be operable to cut or perforate the casing 108 and/or the production tubing 107 to reach the formation 106. The tool 115 may also be or comprise a plug and a corresponding plug setting tool for setting the plug at a predetermined depth within the casing 108 or the production tubing 107 to isolate downhole and uphole portions of the wellbore 102.

Although the tool string 110 is shown comprising five downhole tools 111-115, it is to be understood that the tool string 110 may comprise a greater or lesser number of downhole tools within the scope of the present disclosure. Furthermore, although the tool string 110 is described as comprising the tools 111-115, one or more of the tools 111-115 may not be included within the tool string 110. Also, the tools 111-115 may be included in the tool string in different orders than described above. Lastly, it is to be understood that one or more of the tools 111-115 described above may be included in the tool string 110 as separate and distinct units. However, one or more of the tools 111-115 may also be combined or integrated into a single unit.

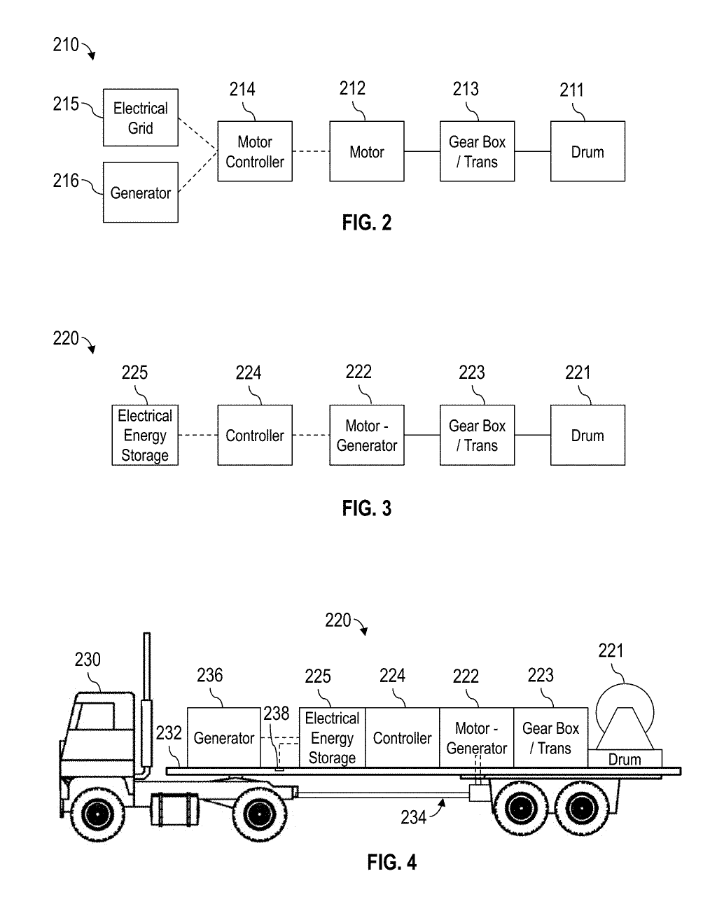

A typical source of electrical energy for supplying electrical energy to a winch system utilized at a wellsite may not be operable to capture mechanical energy and store such energy as electrical energy and, thus, may not include an electrical energy storage, such as the electrical energy storage 168. FIG. 2 is a schematic view of at least a portion of an example implementation of a conveyance system 210 which does not utilize an electrical energy storage. The conveyance system 210 may comprise a drum 211 mechanically connected with a motor 212. The conveyance system 210 may include a gear box or a transmission 213. A motor controller 214 may be electrically connected with the motor 212 to control rotational speed and/or torque applied to the drum 211. The motor controller 214 may receive electrical energy from an electrical grid 215 and/or a generator 216. The conveyance system 210 is not operable to capture and store mechanical energy (i.e., gravitational potential energy) released during downhole conveyance (i.e., running into the wellbore) of a tool string and the supporting line. Such mechanical energy is wasted by generating heat via a space heater for the motor controller 214 and/or an oil cooler when a hydraulic motor is utilized. Furthermore, when utilizing the conveyance system 210, the potential mechanical energy is wasted and not stored during the intended downhole conveyance, resulting in immediate stop of operations in the event of failure of the electrical grid 215 and the generator 216.

A winch system according to one or more aspects of the present disclosure may facilitate power management permitting both autonomy and emission/noise reduction. The winch system may be implemented in various oil field services applications, such as slickline, wireline, multiline, and cementing services, as well as in land and offshore environments. FIG. 3 is a schematic view of at least a portion of an example implementation of a conveyance system 220 according to one or more aspects of the present disclosure. The conveyance system 220 may comprise one or more similar features of the winch conveyance system 150 shown in FIG. 1 and described above. Accordingly, the conveyance system 220 may be utilized at an oil field wellsite, such as the wellsite 100 shown in FIG. 1, to wind and unwind a line 120 to run and retrieve a downhole tool string 110. The following description refers to FIGS. 1 and 3, collectively.

The conveyance system 220 may comprise a drum 221 mechanically connected with a motor-generator 222 operable to receive electrical energy to generate torque and to receive torque to generate electrical energy. The conveyance system 220 may include a gear box or a transmission 223. A controller 224 may be electrically connected with the motor-generator 222 to control rotational speed and/or torque applied to the drum 221. The controller 224 may receive electrical energy from an electrical energy storage unit 225 and direct or otherwise supply electrical energy to the motor-generator 222 when pulling the tool string 110 out of the wellbore 102. The electrical energy storage 225 may be operable to capture and store mechanical energy released during downhole conveyance of the tool string 110 and the supporting line 120. For example, the electrical energy storage 225 may be fed with electrical energy in a regenerative mode when the drum 221 and, thus, the motor-generator 222 are rotated when running the tool string 110 in the wellbore 102. The regenerative operation reduces or eliminates the use of energy dissipating mechanisms such as space heaters and oil coolers. Furthermore, the electrical energy storage 225 may be the primary source of electrical energy to drive the motor-generator 222. The regenerative operation may be self-contained and integral to the conveyance system 220 and may reduce or eliminate safety hazards associated with re-injection of power to the electrical grid.

The motor-generator 222 may be implemented as a three-phase alternating current (AC) brushless induction motor and the controller 224 may be implemented as a reversible three-phase inverter-rectifier. The transmission 223 may be a single or multiple ratio gear box or transmission. The transmission 223 may be or comprise a chain transmission. The electrical energy storage 225 may be or comprise a high-density energy and power battery, fuel cell, and/or capacitor. For example, the electrical energy storage 225 may be or comprise one or more rechargeable batteries, such as lithium ion batteries. The electrical energy storage 225 may also or instead comprise ultra-capacitors comprising electrodes of porous material generally carbon nanotube, soaked in electrolyte separated by a thin insulated layer. The electrical energy storage 225 may comprise, for example, a polymer electrolyte membrane fuel cell (PEMFC) or an alkaline anion exchange membrane fuel cell (AAEMFC).

When the tool string is retrieved (i.e., pulled) out of the wellbore, the electrical energy storage 225 may supply the controller 224 with DC electrical energy, the controller 224 may operate as an inverter to convert the DC electrical energy to a variable frequency three-phase AC electrical energy to operate the motor-generator 222. When the tool string 110 is run into the wellbore 102, motor-generator 222 may be entrained by the weight of the line 120 and the tool string 110 and operate as a generator, delivering variable frequency voltage to the controller 224. The motor-generator 222 may receive torque from the rotatable drum 221 via the transmission 223 to generate AC electrical energy, and the controller 224 may operate as a rectifier to convert the AC electrical energy to DC electrical energy to be stored by the electrical energy storage 225.

In addition to utilizing the weight of the line 120 and the tool string 110 to generate electrical energy while running the tool string 110 in the wellbore 102, a sudden deceleration while pulling the tool string 110 out of the wellbore 102 may also be captured and stored. For example, the kinetic energy (i.e., linear and/or angular momentum) of the moving and rotating parts may be captured by the conveyance system 220 and stored as electrical energy in the electrical energy storage 225.

However, the motor-generator 222 may also or instead be implemented as a DC voltage serial or shunt wound motor, in which case, the controller 224 may be implemented as a DC voltage reversible chopper. Accordingly, the serial or shunt wound motor may be operable to receive DC electrical energy to impart torque to the rotatable drum 221, and receive torque from the rotatable drum 221 to generate DC electrical energy. The electrical chopper may receive and convert a fixed DC electrical energy supplied by the electrical energy storage 225 to a variable DC electrical energy, such as to control torque and/or rotational speed of the serial or shunt wound motor.

The electrical energy storage 225 may also be charged with electrical energy while the conveyance system 220 is transported to the wellsite 104. FIG. 4 is a schematic view of at least a portion of an example implementation of the conveyance system 220, shown in FIG. 3, operable to be charged while being transported by a vehicle 230 according to one or more aspects of the present disclosure. During transportation of the conveyance system 220, the engine (not shown) of the vehicle 230 may be utilized to charge the electrical energy storage 225. For example, the conveyance system 220 may be disposed on a bed 232 of the vehicle 230 and the engine may be mechanically connected with the motor-generator 222 via a mechanical linkage system 234, such as may comprise a vehicle drive axel, a gear box, and other linkages collectively operable to transfer torque from the engine to the motor-generator 222. The electrical energy storage 225 may also or instead be electrically connected with a generator 236 carried by the vehicle 230. The electrical energy storage 225 may also or instead be electrically connected with an internal electrical system of the vehicle 230 via an electrical outlet 238. The internal electrical system of the vehicle 230 may be powered by an alternator (not shown) of the vehicle 230. The vehicle 230 may be utilized to charge the electrical energy storage 225, for example, in environmentally sensitive areas and/or urban areas.

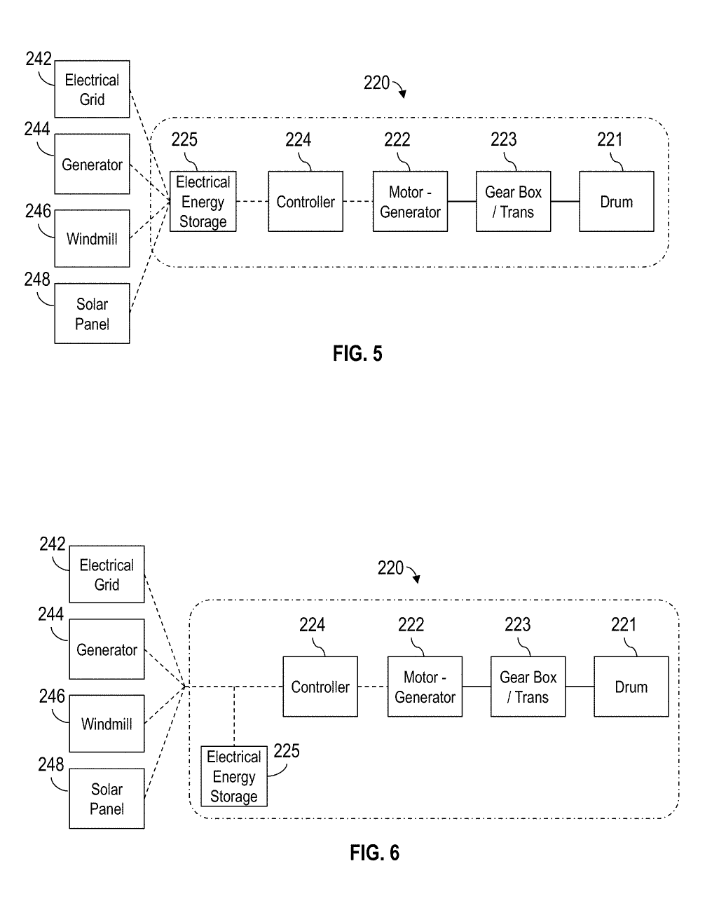

FIGS. 5 and 6 are a schematic views of the conveyance system 220 shown in FIG. 3 electrically connected with external sources of electrical energy to supply electrical energy to the motor-generator 222. As shown in FIG. 5, the electrical energy storage 225 of the conveyance system 220 may be electrically connected with one or more of an electrical grid 242, a generator 244, a windmill 246, and a solar panel 248, which may charge the electrical energy storage 225. Such use of external sources of electrical energy may be compatible with a non-continuous source of energy and/or an energy source with continuous capacity substantially lower than an intermittent demand of the oil field applications. As shown in FIG. 6, the external sources of electrical energy may be electrically connected with both the electrical energy storage 225 and the controller 224 of the conveyance system 220. Thus, one or more of the external sources of electrical energy may supply electrical energy to the conveyance system 220 as primary sources of electrical energy, while maintaining the electrical energy storage 225 charged. The electrical energy storage 225 may thus be utilized as a secondary source of electrical energy, such as when the external sources failed or are otherwise unavailable.

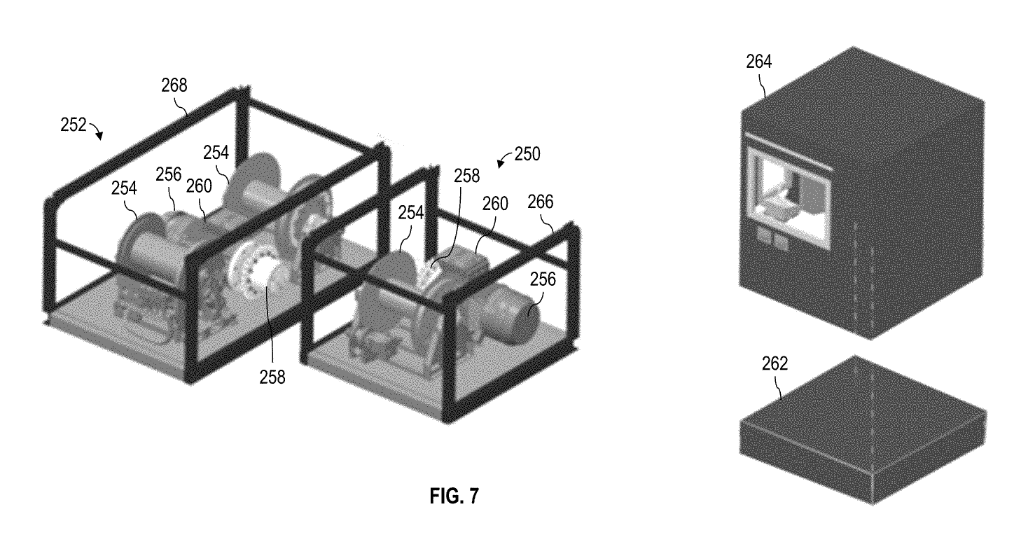

FIG. 7 is a perspective view of at least a portion of example implementations of winch conveyance systems 250, 252 according to one or more aspects of the present disclosure. The winch conveyance systems 250, 252 may be utilized at an oil field wellsite, such as the wellsite system 100 shown in FIG. 1, to wind and unwind a line to run and retrieve a downhole tool string. The winch conveyance systems 250, 252 may be further operable to capture mechanical energy released during running operations and store the mechanical energy as electrical energy. The winch conveyance systems 250, 252 may selectively release the stored electrical energy during retrieval or pulling operations. The winch conveyance systems 250, 252 may comprise one or more similar features of the conveyance systems 150, 220 shown in FIGS. 1 and 3, respectively, and described above. The following description refers to FIGS. 1 and 7, collectively.

The winch conveyance system 250 may comprise a drum 254 mechanically connected with a motor-generator 256 operable to receive electrical energy to generate torque and to receive torque to generate electrical energy. The winch conveyance system 250 may include a gear box or a transmission 258. A controller 260 may be electrically connected with the motor-generator 256 to control rotational speed and/or torque applied to the drum 254. The winch system 252 may comprise a similar structure and mode of operation as the winch conveyance system 250, but include two drums 254. Thus, the winch system 252 may be operable to wind and unwind two different lines.

The controller 260 may receive electrical energy from an electrical energy storage unit 262. The electrical energy storage 262 may supply electrical energy to each motor-generator 256 when pulling a tool string 110 out of a wellbore 102. The electrical energy storage 262 may capture and store electrical energy released as mechanical energy during downhole conveyance of the tool string 110 and the supporting line 120. For example, the electrical energy storage 262 may be fed with electrical energy in a regenerative mode when the drum 254 and, thus, the motor-generator 256 are rotated when running the downhole tool string 110 in the wellbore 102. The electrical energy storage 262 maybe installed adjacent the winch conveyance system 250, 252 and/or a control center 264 (e.g., control cabin). When utilized at an offshore rig, the electrical energy storage 262 may be installed underneath the control center 264. An example implementation of the electrical energy storage 262 may comprise a width of about 2.0 meters (6.56 feet), a depth of about 2.0 meters (6.56 feet), and a height of about 0.25 meters (0.82 feet).

Each winch conveyance system 250, 252 may have a corresponding frame assembly 266, 268 extending around the winch conveyance system 250, 252 to help maintain the drums 254, the motor-generators 256, the transmissions 258, and the controllers 260 operatively connected and/or in relative positions. Each frame assembly 266, 268 may be a box-shaped frame encompassing or surrounding the components of the winch conveyance systems 250, 252 on each side. The frame assemblies 266, 268 may be or comprise a plurality of interconnected structural steel members or beams extending about and connected with the components of the winch conveyance systems 250, 252. The frame assemblies 266, 268 may be a load-bearing frame assemblies operable to support the weight of one or more additional instances of the winch conveyance systems 250, 252 vertically stacked on top of each winch conveyance system 250, 252. Thus, each frame assembly 266, 268 may protect the components of the winch conveyance systems 250, 252 from physical damage during transport, assembly, and operations and help facilitate transportation of the winch conveyance systems 250, 252. The frame assemblies 266, 268 may facilitate the winch conveyance systems 250, 252 to be implemented as skids, which may be moved and/or temporarily or permanently installed at the wellsite 104. The frame assemblies 266, 268 may also permit the winch conveyance systems 250, 252 to be mounted on a truck trailer, such as may permit transportation to the wellsite 104.

For example, the frame assemblies 266, 268 may be constructed pursuant to International Organization for Standardization (ISO) specifications, permitting the winch conveyance systems 250, 252 to be transported like intermodal ISO containers. Accordingly, the frame assemblies 266, 268 may form or comprise corner castings (not shown), such as may facilitate the winch conveyance systems 250, 252 to be fixedly mounted on a transport surface, such as a truck trailer and/or multiple winch conveyance systems 250, 252 to be stacked vertically on top of each other or connected together horizontally. The corner castings may be constructed pursuant to ISO specifications, such as may permit the winch conveyance systems 250, 252 to be transported across different modes of transport within the global containerized intermodal freight transport system or other transport means adapted to receive standardized ISO containers. The frame assemblies 266, 268 may further comprise or form forklift or grappler pockets (not shown), such as may permit the winch conveyance systems 250, 252 to be picked up and moved by a forklift, a grappler, and/or a crane equipped with grappler tongs.

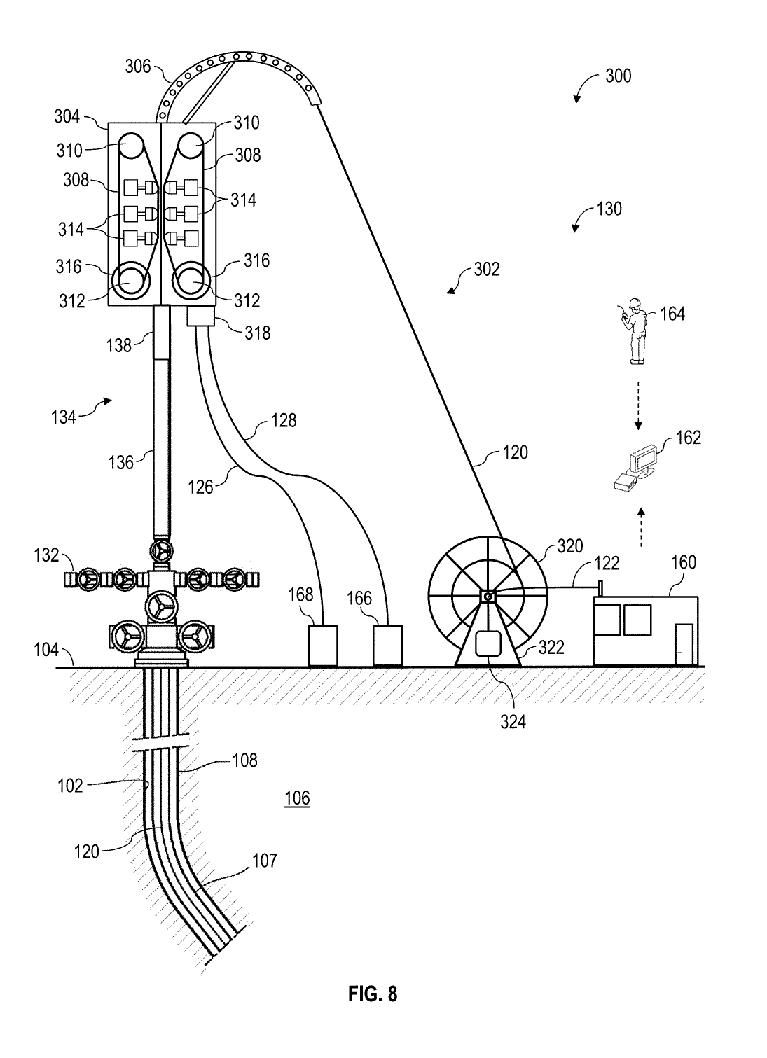

Instead of or in addition to a winch system, an injector system may be utilized to run and retrieve a downhole tool string into and out of a wellbore. FIG. 8 is a schematic view of at least a portion of an example implementation of a wellsite system 300 comprising an injector conveyance system 302 according to one or more aspects of the present disclosure. The wellsite system 300 represents an example environment in which one or more aspects of the present disclosure, including the injector conveyance system 302, may be implemented. It is also noted that although the wellsite system 300 is depicted as an onshore implementation, it is understood that the aspects described below are also generally applicable to offshore and inshore implementations. The wellsite system 300 may comprise one or more similar features of the wellsite system 100 shown in FIG. 1 and described above, including where indicated by like reference numbers, except as described below.

The injector conveyance system 302 may comprise an injector head 304 operable to run and retrieve the line 120 into and out of the wellbore 102. A gooseneck 306 may be mounted on top of the injector head 304 to feed or direct a line 120 around a controlled radius into the injector head 304. The injector head 304 may comprise opposing circulating members, such as may be operable to compress or otherwise grip the line 120 to support the weight of the downhole tool string 110 (shown in FIG. 1) within the wellbore 102. For example, the injector head 304 may be a belt-type injector head comprising a pair of opposing belts 308 circulated by upper and lower rollers 310, 312. A corresponding set of cylinders 314 may push each belt 308 against the line 120 to maintain a sufficient pressure and, thus, friction between the belts 308 and an outer surface of the line 120 to grip the line 120. In an example implementation, the belts 308 may comprise rubber, such as (EPDM). However, an implementation of the injector head 304 may comprise chains instead of the belts 308. The line 120 may have a composite slick outer layer comprising a thermoplastic, such as a member of polyetheretherketone family. For example, the line 120 may have a setting strength of 10 tons over a 12.70 centimeter (5 inch) length of 0.318 millimeter (0.0125 inch) line is necessitated to pull 700 kilograms. The injector head 304 may be mounted to or otherwise above a stuffing box 138 operable to fluidly seal against the line 120 as it exits or enters the injector head 304.

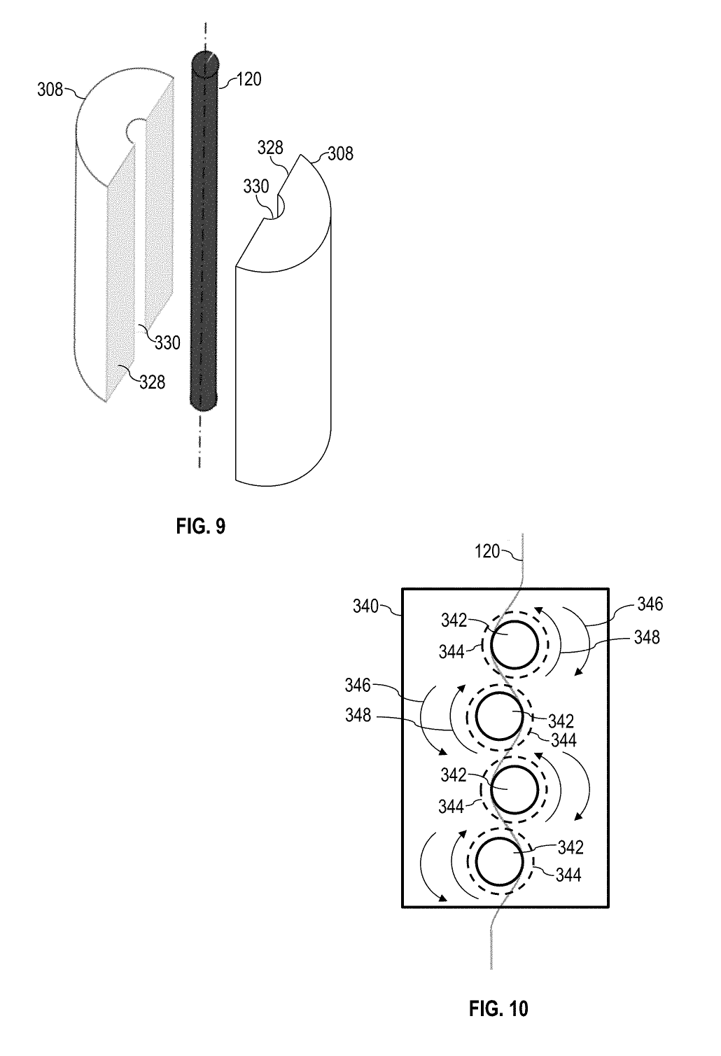

FIG. 9 is a perspective view of a segment of the line 120 disposed between the opposing belts 308 according to one or more aspects of the present disclosure. Each belt 308 may comprise a semicircular cross-section, comprising a flat surface 328 configured to be pressed against the line 120. Each flat surface 328 of the belts may comprise a groove or channel 330 extending longitudinally along the flat surface 328 of each belt 308. The channel 330 may comprise a cylindrical profile, such as may accommodate therein and/or optimize the area of contact between the line 120 and the belts 320.

Referring again to FIG. 8, one or more of the rollers 310, 312 may be operated by a corresponding motor 316 mechanically connected with the rollers 310, 312. A gear box or transmission (not shown) may be mechanically or otherwise operatively connected between each motor 316 and the corresponding rollers 310, 312, such as may facilitate control of rotational speed and torque applied to the rollers 310, 312. When the motors 316 are implemented as hydraulic motors, a pump may be driven by an engine or an electric motor to supply hydraulic energy. The hydraulics system may provide variable speed commands. When the motors 316 are implemented as electrical motors, the motors 316 may be electrically connected with an electrical motor controller 318 (e.g., a variable frequency drive, a chopper) operable to control the speed and/or torque of the motors 316, such as by controlling the frequency and/or the amplitude of the electrical energy supplied to the motors 316. Electrical energy may be supplied to the injector conveyance system 302 from one or more of an electrical generator unit 166, an electrical energy storage unit 168, and an external electrical energy source (not shown) electrically connected with the injector conveyance system 302. Although the injector head 304 is shown mounted above the lock chamber 136 and the stuffing box 138, the injector head 304 may be installed or otherwise disposed within the pressure contained volume of the lock chamber 136, below the stuffing box 138.

FIG. 10 is a schematic view of at least a portion of an example implementation of an injector head 340 according to one or more aspects of the present disclosure. The injector head 340 may comprise a plurality of motorized pulleys 342 disposed vertically with respect to each other and collectively operable to circulate or otherwise move a line 120. One or more (e.g., all) of the pulleys 342 may be driven by a corresponding motor 344. In implementations comprising a plurality of motors 344, such motors 344 may be synchronized electrically. However, in implementations comprising a single motor (not shown), the pulleys 342 may be driven by a chain or a belt (not shown) driven by such single motor. The pulleys 342 may be offset horizontally from each other and the line 120 may be wound around at least a portion of each pulley 342, which may provide both tension and surface area to permit the pulleys 342 to grip and, thus, move the line 120 to convey a tool string 110 (shown in FIG. 1) as described above. The motors 344 may rotate as depicted by arrows 348 to move the line 120 and, thus, the tool string 110 in the downhole direction, and the motors 344 may rotate as depicted by arrows 346 to move the line 120 and, thus, the tool string 110 in the uphole direction. Similarly as the injector head 304, the injector head 340 may be installed as part of the conveyance system 302 and operably connected with the reel 320 and the electrical energy source 168. Each motor 342 may be implemented as a motor-generator operable both as a motor and a generator, similarly to the motor-generator 154, 222 described above.

The injector conveyance system 302 may further comprise a reel 320 (e.g., a drum or spool) configured to store thereon a wound length of the line 120. The reel 320 may be rotatably connected with a stationary frame or base 322, such that the reel 320 may be selectively rotated to unwind and wind the line 120 to provide the line 120 for deployment into the wellbore 102 and to receive the line 120 retrieved from the wellbore 102. The reel 320 may be rotated by a motor 324, such as a hydraulic or electric motor, or by other means. During operations, the line 120 between the injector head 304 and the reel 320 and, thus, the line 120 wound on the reel 320 may be substantially free of tension, as the injector head 304 supports the entire or at least a substantial portion of the weight of the tool string 110. However, the motor 324 may impart tension to the line 120 to wind the line onto the reel 320 independent of the tension of the line 120 supported by the injector head 304. The reel 320 may be substantially larger than a drum of a winch system, comprising a radius of up to about 2.54 meters (100 inches).

In an example implementation, the line 120 may be a mechanical and/or electrical composite line having an outside diameter between about 0.274 centimeters (0.108 inches) and about 0.406 (0.160 inches). Utilizing a typical winch system to run and retrieve the downhole tool string 110 into and out of the wellbore 102 via such composite line 120 may limit operational life of the line 120 and speed up its failure. For example, winding the composite line 120 around small diameter drums of a typical winch system and passing the line 120 through small diameter sheaves, while under tension, may unduly bend or kink the line 120 imparting excessive stresses and strains that may lead to accelerated failure of the line 120.

The control center 160 and/or processing device 162 may be communicatively connected with various equipment of the wellsite system 300 described herein, such as may permit the processing device 162 to receive signals from and transmit signals to such equipment to perform various wellsite operations described herein. The control center 160 may be communicatively and/or electrically connected with the injector conveyance system 302 wirelessly or via a conduit (not shown). The control center 160 may be communicatively and/or electrically connected with the tool string 110 via the line 120 and a conduit 122 connected with the line 120 via a rotatable joint or coupling (e.g., a collector) (not shown) carried by the reel 320.

In addition running and retrieving the downhole tool string 110, similarly to the winch conveyance system 150, the injector conveyance system 302 (comprising either the injector head 304 shown in FIG. 8 or the injector head 340 shown in FIG. 10) may be further operable to capture mechanical energy released during the running operations and store the mechanical energy as electrical energy and optionally selectively release the stored electrical energy during subsequent retrieval or pulling operations. To capture the mechanical energy in the form of electrical energy, each motor 316 may be or comprise a motor-generator operable as a motor and a generator and the motor controller 318 may be or comprise a controller, such as a bi-directional converter or controller operable to condition and transfer the electrical energy in both directions between the motor-generator 316 and the electrical energy storage 168. For example, when the tool string 110 is run into the wellbore 102, the motor-generator 316 may be entrained by the weight of the line 120 and the tool string 110 and operate as a generator, delivering electrical energy to the controller 318. During running operations, the motor-generator 316 may receive torque from the rotating rollers 310, 312, perhaps via a transmission, to generate the electrical energy, and the controller 318 may direct the generated electrical energy to the electrical energy storage 168 to be stored. Thereafter, the electrical energy storage 168 may supply the controller 318 with electrical energy to operate the motor-generator 316 to retrieve the tool string 110 out of the wellbore 102.

Generally, the injector conveyance system 302 may comprise substantially configuration and mode of operation as the conveyance systems 150, 220 described above and shown in FIGS. 1 and 3, except that the conveyance is performed by the injector head 304, 340 rather than a winch.

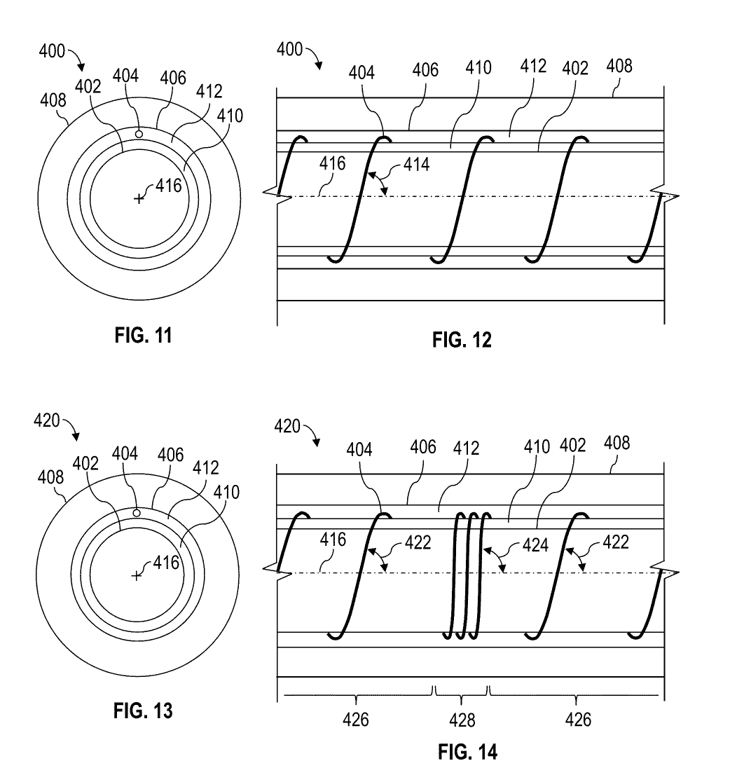

The present disclosure is further directed to a cable or line, which may be utilized to run and retrieve a tool string into and out of a wellbore. FIGS. 11 and 12 are axial and side sectional views, respectively, of an example implementation of a slickline 400 according to one or more aspects of the present disclosure. The slickline 400 may comprise one or more similar features of the line 120 shown in FIGS. 1 and 8 and described above. Accordingly, similarly to the line 120, the slickline 400 may be utilized at oil field wellsites, such as the wellsites 100, 300 shown in FIGS. 1 and 8, to run and retrieve a downhole tool string 110. The following description refers to FIGS. 11 and 12, collectively.

The slickline 400 may be a composite slickline, comprising a core 402 extending axially along the length of the slickline 400 and an optical fiber 404 wound around the core 402 in a spiral (i.e., helical) configuration. The optical fiber 404 may be embedded within a plastic material 406 such that the optical fiber 404 is positioned at a distance from (i.e., not in contact with) the core 402. The plastic material 406 may be or comprise, where higher strength and temperature resistance is sought, for example, a polyetheretherketone (PEEK), such as may comprise one or more members of the polyetheretherketone family, or a similarly pure or amended polymer. The plastic material 406 may include a carbon fiber reinforced PEEK, short-fiber-filled polyetheretherketone (SFF-PEEK), polyether ketone, and polyketone, polyaryletherketone.

The spiral configuration of the optical fiber 404 may comprise a substantially constant pitch, resulting in the optical fiber 404 forming a substantially constant angle 414 (i.e., helix angle) with respect to an axis 416 of the slickline 400. The core 402 may be or comprise austenitic stainless steel and/or carbon steel. However, the core 402 may be a composite core, comprising aramid and/or carbon fibers. The optical fiber 404 may be or comprise a silica glass fiber, while the plastic material 406 may be or comprise a thermoplastic, such as a member of the polyetheretherketone family. A plastic layer 408, such as an external jacket, may cover the plastic material 406.

The spiral configuration of the optical fiber 404 prevents or reduces transfer of tension and/or compression shocks from the core 402 to the optical fiber 404 while the plastic material 406 maintains the optical fiber 404 in position around, but not in contact with the core 402. The plastic material 406 may also protect the optical fiber 404 from physical contact and damage caused by external elements. The diameter of the core 402 may be, for example, about 0.208 centimeters (0.082 inches) and the outer diameter of the composite slickline 400 may be, for example, about 0.318 centimeters (0.125 inches).

The slickline 400 may be manufactured by covering the core 402 with a first layer 410 (i.e. a radially inner or sub layer of the plastic material 406) of plastic material 406, wrap the plastic layer 410 with the optical fiber 404 in a spiral configuration, and then cover the plastic layer 410 and the optical fiber 404 with a second layer 412 (i.e., a radially outer or top layer of the plastic material 406) of the same plastic material. Accordingly, the first and second layers 410, 412 may form the plastic material 406. The plastic material 406 may then be covered by the layer 408.

FIGS. 13 and 14 are axial and side sectional views, respectively, of an example implementation of a composite slickline 420 according to one or more aspects of the present disclosure. The slickline 420 may comprise one or more similar features of the slickline 400 shown in FIGS. 11 and 12 and described above, including wherein indicated by the same reference numbers. The following description refers to FIGS. 13 and 14, collectively.

The spiral configuration of the optical fiber 404 of the slickline 420 may comprise a changing pitch, resulting in the optical fiber 404 forming different helix angles 422, 424 with respect to an axis 416 of the slickline 400. For example, the pitch of the optical fiber 404 spiral may change at regular intervals, comprising alternating greater pitch intervals 426 and lesser pitch intervals 428. The lesser pitch intervals 428 may operate as tags, such as may be utilized for measuring the length of the slickline 420 and/or to locate measurements on the slickline 420. Such measurements may be taken or determined during maintenance operations, such as a distributed maintenance log. Other measurements utilizing the slickline 420 may be taken or determined during measurements of the environment of the slickline 420, such as a distributed temperature measurement technics. For example, laser technics of measurement via optical fibers permit measurement of local changes to the optical fiber caused by mechanical changes, such as due to tension, compression, bending, and/or temperature changes.

Although FIGS. 11-14 show the slicklines 400, 420 comprising the optical fiber 404 wound around the core 402 and embedded within the plastic material 406, the optical fiber 404 may be replaced with a metallic fiber or wire, such as may permit electrical energy or electrical signals to be transmitted therethrough. Furthermore, a slickline within the scope of the present disclosure may comprise one or more of each of the optical fiber 404 and the metallic wire wound around the core 402 and embedded within the plastic material 406. Furthermore, although FIGS. 11-14 show the optical fiber 404 disposed at a distance from the first layer 410 of plastic material the optical fiber 404 is wound upon, it is to be understood that the optical fiber 404 may be disposed closer to or in contact with the layer 410 of plastic material, such as when the optical fiber 404 is wound about the layer 410 of plastic material.

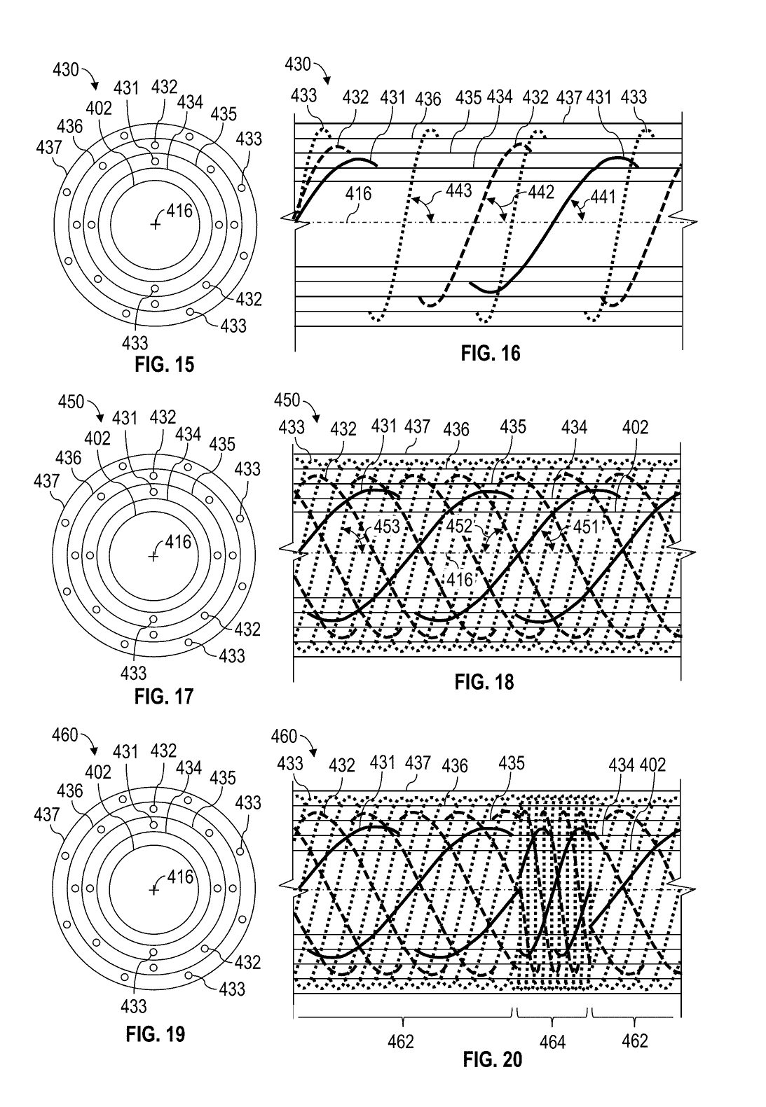

FIGS. 15 and 16 are axial and side sectional views, respectively, of an example implementation of a composite slickline 430 according to one or more aspects of the present disclosure. The slickline 430 may comprise one or more similar features of the slicklines 400, 420 shown in FIGS. 11-14 and described above, including wherein indicated by the same reference numbers. The following description refers to FIGS. 15 and 16, collectively.

The slickline 430 may comprise one or more sets of reinforcement members 431, 432, 433 (e.g., wires) wound around the core 402 in a spiral configuration. The reinforcement members 431, 432, 433 of each reinforcement set may be disposed between (e.g., covered by, embedded within) a corresponding layer 434, 435, 436, 437 of plastic material such that each set of reinforcement members 431, 432, 433 is positioned at a predetermined radial distance from the core 402. For example, each set of reinforcement members 431, 432, 433 may be wound around the corresponding layer 434, 435, 436 of plastic material at progressively increasing radial distances away from the core 402, forming layers of reinforcement members 431, 432, 433 surrounding the core 402. It is to be noted that for clarity and ease of understanding, FIG. 16 shows just one reinforcement member of each layer of reinforcement members 431, 432, 433.

Similarly as described above, each plastic layer 434, 435, 436, 437 may be manufactured by covering the core 402 a layer 434 of plastic material and then, alternatingly, wrapping each plastic layer 434, 435, 436 with a corresponding reinforcement member 431, 432, 433 in a spiral configuration and covering each reinforcement member 431, 432, 433 and plastic layer 434, 435, 436 with a subsequent layer 435, 436, 437 of the same plastic material. The plastic layers 434, 435, 436, 437 may protect the reinforcement members 431, 432, 433 from physical contact with the core 402 and each other, and from damage caused by external elements.

The spiral configuration of each reinforcement member 431, 432, 433 may comprise a different pitch, resulting in each reinforcement member 431, 432, 433 forming a different angle 441, 442, 443 (i.e., helix angle) with respect to the axis 416 of the slickline 430. For example, each successive radially outward reinforcement member 431, 432, 433 may comprise a progressively increasing angle 441, 442, 443 (i.e., progressively decreasing pitch). The angles 441, 442, 443 may range between about zero degrees closest to the core 402 and about 90 degrees furthest from the core 402. In an example implementation, the angle 441 may range between about zero degrees and about 40 degrees, and the angle 443 may range between about the angle 442 and about 90 degrees. The angle 442 may be an intermediate angle sized between the angles 441, 443. In another example implementation, the reinforcement members of the reinforcement layer located at the greatest radial distance from the core 402, such as the reinforcement member 433, may form an angle ranging between about 40 degrees and about 60 degrees.

Each reinforcement member 431, 432, 433 may be or comprise a single carbon fiber or a bundle of carbon fibers. Each reinforcement member 431, 432, 433 may also or instead comprise the material forming the core 402. The plastic material forming the plastic layers 434, 435, 436, 437 may be or comprise a thermoplastic, such as a member of the polyaryletherketone family. The diameter of the core 402 may be, for example, about 0.208 centimeters (0.082 inches) and the outer diameter of the composite slickline 430 may be, for example, about 0.318 centimeters (0.125 inches).

Although the slickline 430 is shown comprising three reinforcement layers, each comprising four, eight, and eight, reinforcement members 431, 432, 433, the slickline 430 within the scope of the present disclosure may comprise one, two, four, or more reinforcement layers, each comprising one reinforcement member 431, 432, 433 or a plurality of reinforcement members 431, 432, 433. For example, each reinforcement layer may comprise between one and ten reinforcement members 431, 432, 433 or more.

FIGS. 17 and 18 are axial and side sectional views, respectively, of an example implementation of a composite slickline 450 according to one or more aspects of the present disclosure. The slickline 450 may comprise one or more similar features of the slicklines 400, 420, 430 shown in FIGS. 11-16 and described above, including wherein indicated by the same reference numbers. The following description refers to FIGS. 17 and 18, collectively.

Similarly as described above, the slickline 450 may comprise one or more layers of reinforcement members 431, 432, 433 wound around the core 402 in a spiral configuration. The reinforcement members 431, 432, 433 of each reinforcement layer may be disposed between (e.g., covered by, embedded within) a corresponding layer 434, 435, 436, 437 of plastic material such that each set of reinforcement members 431, 432, 433 is positioned at a predetermined radial distance from the core 402. However, unlike the slickline 430, the reinforcement members 431, 432, 433 of some of the reinforcement layers may be laid (e.g., wound) in opposing directions forming opposing helix angles with respect to an axis 416 of the slickline 450. For example, the reinforcement members 431, 432, 433 of each consecutive reinforcement layer may be laid in opposing directions to form a mesh of reinforcement members 431, 432, 433 for cohesiveness of reinforcement. As shown in FIG. 18, the reinforcement members 431, 433 of the radially inner and outer reinforcement layers may be wound in the same direction forming angles 451, 453, respectively, while the reinforcement members 432 of the intermediate reinforcement layer may be wound in an opposing direction forming an opposing angle 452. Therefore, the reinforcement members 431, 432, 433 may form alternating right-handed and left-handed spirals or helices. For example, the reinforcement members 431, 433 may be wound in a left-handed spiral configuration, while the reinforcement member 432 may be wound in a right-handed spiral configuration. The angles 451, 452, 453 may range between about zero degrees closest to the core 402 and about 90 degrees furthest from the core 402. In an example implementation, the angle 451 may range between about zero degrees and about 40 degrees, and the angle 453 may range between about 40 degrees and about 90 degrees. The angle 452 may be an intermediate angle sized between the angles 451, 453. In another example implementation, the reinforcement members of the reinforcement layer located at the greatest radial distance from the core 402, such as the reinforcement member 433, may form an angle ranging between about 40 degrees and about 60 degrees.

Although the slickline 450 is shown comprising three reinforcement layers, each comprising four, eight, and eight, reinforcement members 431, 432, 433, respectively, the slickline 430 within the scope of the present disclosure may comprise one, two, four, or more reinforcement layers, each comprising one reinforcement member 431, 432, 433 or a plurality of reinforcement members 431, 432, 433. For example, each reinforcement layer may comprise between one and ten reinforcement members 431, 432, 433 or more.

FIGS. 19 and 20 are axial and side sectional views, respectively, of an example implementation of a composite slickline 460 according to one or more aspects of the present disclosure. The slickline 460 may comprise one or more similar features of the slicklines 400, 420, 430, 450 shown in FIGS. 11-18 and described above, including wherein indicated by the same reference numbers. The following description refers to FIGS. 19 and 20, collectively.

Similarly as described above, the slickline 460 may comprise one or more layers of reinforcement members 431, 432, 433 wound around the core 402 in a spiral configuration. The reinforcement members 431, 432, 433 of each reinforcement layer may be disposed between (e.g., covered by, embedded within) a corresponding layer 434, 435, 436, 437 of plastic material such that each set of reinforcement members 431, 432, 433 is positioned at a predetermined radial distance from the core 402.

However, unlike the slickline 450, the spiral configuration of the reinforcement members 431, 432, 433 may comprise a changing pitch, resulting in the reinforcement members 431, 432, 433 forming different helix angles with respect to an axis 416 of the slickline 460. For example, the pitch of the spiral of the reinforcement members 431, 432, 433 may increase and decrease at regular intervals, comprising alternating greater pitch intervals 462 wherein the reinforcement members 431, 432, 433 are laid less tightly, and lesser pitch intervals 464 wherein the reinforcement members 431, 432, 433 are laid more tightly. The lesser pitch intervals 464 may be optimal intervals at which the slickline 460 may be bent, especially when the slickline 460 is under tension. The lesser pitch intervals 464 of each reinforcement member 431, 432, 433 coincide along the axis 416 and the greater pitch intervals 462 of each reinforcement member 431, 432, 433 also coincide along the axis 416.

Although FIGS. 15-20 show the slicklines 430, 450, 460 comprising the reinforcement members 431, 432, 433 wound around the core 402 and disposed between or covered by corresponding plastic layers 434, 435, 436, 437, one or more of the reinforcement members 431, 432, 433 or layers of reinforcement members 431, 432, 433 may be replaced with one or more optical fibers 404 operable to conduct optical signals and/or one or more electrical conductors, such as metallic fibers or wires, operable to conduct electrical energy or electrical signals. Furthermore, although FIGS. 15-20 show the reinforcement members 431, 432, 433 disposed at a distance from the corresponding layers 434, 435, 436 of plastic material the reinforcement members 431, 432, 433 were wound upon, it is to be understood that the reinforcement members 431, 432, 433 may be disposed closer to or in contact with the corresponding previous layers 434, 435, 436 of plastic material, such as when the reinforcement members 431, 432, 433 are wound about the corresponding previous layers 434, 435, 436 of plastic material.

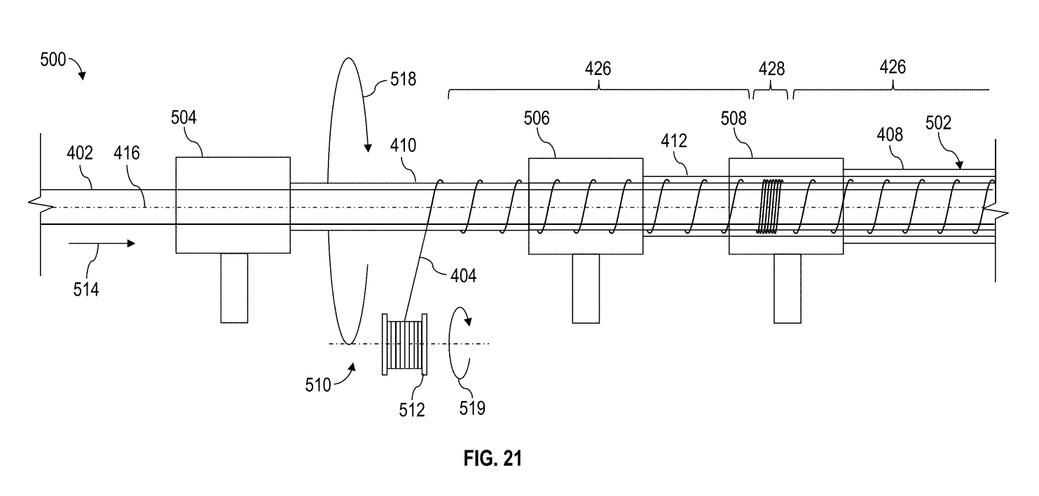

The present disclosure is also directed to methods or processes for manufacturing or otherwise forming one or more slicklines within the scope of the present disclosure. FIG. 21 is a schematic side view of an example implementation of an apparatus 500 operable to form a slickline 502 according to one or more aspects of the present disclosure. The slickline 502 may comprise one or more features of the slicklines 400, 420 shown in FIGS. 11-15 and described above, including where indicated by the same reference numbers. The following description refers to FIGS. 11-15 and 21, collectively.

The apparatus 500 may comprise coating units 504, 506, 508 (e.g., extruders, fluidized beds, taping units) each operable to successively receive therethrough a core 402 of the slickline 502 and coat the core 402 with a layer of plastic material. The apparatus 500 may further include a winding apparatus 510 operable to wind an optical fiber 404 around the core 402 or a plastic layer covering the core 402. The apparatus 500 may comprise or hold a spool 512 containing the optical fiber 404. The spool 512 may be rotated about its axis of rotation and revolved around the core 402 to wind the optical fiber 404 around the core 402 and/or about a plastic layer covering the core 402.

The method or process for manufacturing or otherwise forming the slickline 502 may comprise running (i.e., axially moving) the core 402 of the slickline 502 at a constant linear velocity, as indicated by arrow 514, through the apparatus 500. As the core 402 is being run, the first coating unit 504 may be operated to extrude or otherwise form a first layer 410 of plastic material around the core 402. The winding apparatus 510 may also be operated to rotate the spool 512 to unwind the optical fiber 404, as indicated by arrow 519, and to revolve the spool 512 around the core 402 at a constant speed, as indicated by arrow 518, to wrap or wind the optical fiber 404 about the first plastic layer 410 in a spiral or helical configuration at a constant speed, resulting in a constant pitch and angle 414 with respect to an axis 416 of the slickline 502. As the core 402 continues to run, the second coating unit 506 may be operated to form a second layer 412 of the same plastic material around the first plastic layer 410 and the optical fiber 404, embedding the optical fiber 404 within the plastic material 406. As described above, the first and second plastic layers 410, 412 may be or form radially inner and outer halves of the plastic material 406 in which the optical fiber 404 is embedded. Lastly, the third coating unit 508 may be operated to form a third layer 408 (e.g., external jacket) of a plastic material around the second plastic layer 412.

The angles 414, 424 may be selected or otherwise formed by controlling the ratio between the linear speed 514 of the core 402 and the speed of revolution 518 of the optical fiber 404. During the slickline 502 forming operations, the winding apparatus 510 may be operated to increase or decrease the speed at which the spool 512 revolves 518 around the core 402 to change the pitch and, thus, the angle 424 of the optical fiber 404 with respect to the axis 416. Thus, periodically changing the speed at which the spool 512 revolves around the core 402 may form alternating high pitch lesser angle 422 intervals 426 and low pitch greater angle 424 intervals 428 of the optical fiber 404.

Although FIG. 21 and the associated text describes the slickline 502 being formed with the optical fiber 404, it is to be understood that the optical fiber 404 may be replaced with a an electrical conductor, such as may permit electrical energy or electrical signals to be transmitted therethrough. Furthermore, the slickline 502 within the scope of the present disclosure may be formed with one or more of each of the optical fiber 404 and the metallic wire wound around the first plastic layer 410 and covered with the second plastic layer 412.

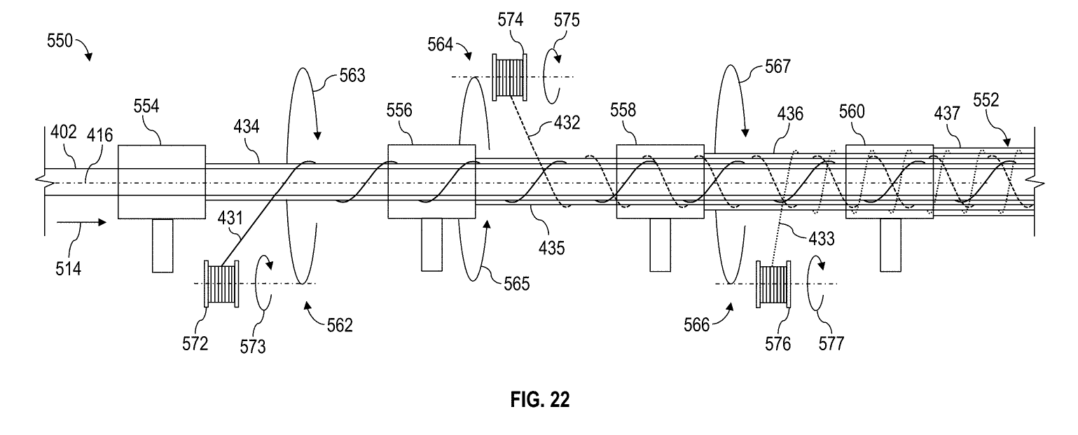

FIG. 22 is a schematic side view of an example implementation of an apparatus 550 operable to form a slickline 552 according to one or more aspects of the present disclosure. The slickline 552 may comprise one or more features of the slicklines 430, 450, 460 shown in FIGS. 15-20 and described above, including where indicated by the same reference numbers. The following description refers to FIGS. 15-20 and 22, collectively.

The apparatus 550 may comprise coating units 554, 556, 558, 560 each operable to successively receive therethrough a core 402 of the slickline 552 and coat the core 402 with a layer of plastic material. The apparatus 550 may further comprise winding apparatuses 562, 564, 566 operable to wind corresponding reinforcement members 431, 432, 433 around the core 402 or a plastic layer covering the core 402. Each winding apparatus 562, 564, 566 may comprise or hold a corresponding spool 572, 574, 576 containing the reinforcement member 431, 432, 433. The spools 572, 574, 576 may be rotated about their axes of rotation and revolved around the core 402 to wind the reinforcement member 431, 432, 433 around the core 402 and/or about a corresponding plastic layer covering the core 402.

The method or process for manufacturing or otherwise forming the slickline 552 may comprise running the core 402 of the slickline 552 at a constant linear velocity, as indicated by arrow 514, through the apparatus 550. As the core 402 is being run, the first coating unit 554 may be operated to extrude or otherwise form a first layer 434 of plastic material around the core 402. The first winding apparatus 562 may be operated to rotate the spool 572 to unwind the first reinforcement member 431, as indicated by arrow 573, and to revolve the spool 572 around the core 402 at a constant speed, as indicated by arrow 563, to wrap or wind the first reinforcement member 431 about the first plastic layer 434 in a spiral or helical configuration at a constant pitch and angle 451 with respect to an axis 416 of the slickline 552. As the core 402 continues to run, the second coating unit 556 may be operated to form a second layer 435 of the same plastic material around the first plastic layer 434 and the first reinforcement member 431, covering or embedding the first reinforcement member 431 beneath (i.e., within) the second plastic layer 435.

While the core 402 continues to run, the second winding apparatus 564 may be operated to rotate the spool 574 to unwind the second reinforcement member 432, as indicated by arrow 575, and to revolve the spool 574 around the core 402 at a constant speed, as indicated by arrow 565, to wrap or wind the second reinforcement member 432 about the second plastic layer 435 in a spiral or helical configuration at a constant pitch and angle 452 with respect to the axis 416 of the slickline 552. The spool 574 may be revolved 565 in a direction that is opposite to the direction that the spool 572 is revolved 563 in. Furthermore, the spool 574 may be revolved 565 at a speed that is faster than the speed at which the spool 572 is revolved 563, resulting in the second reinforcement member 432 comprising a spiral pitch that is lesser than the spiral pitch of the first reinforcement member 431 and an angle 452 that is greater than the angle 451 of the first reinforcement member 431. As the core 402 continues to run, the third coating unit 558 may be operated to form a third layer 436 of the same plastic material around the second plastic layer 435 and the second reinforcement member 432, covering or embedding the second reinforcement member 432 beneath the third plastic layer 436.

While the core 402 continues to run, the third winding apparatus 566 may be operated to rotate the spool 576 to unwind the third reinforcement member 433, as indicated by arrow 577, and to revolve the spool 576 around the core 402 at a constant speed, as indicated by arrow 567, to wrap or wind the third reinforcement member 433 about the third plastic layer 436 in a spiral or helical configuration at a constant pitch and angle 453 with respect to the axis 416 of the slickline 552. The spool 576 may be revolved 567 in a direction (e.g., clockwise or right-handed direction) that is opposite to the direction (e.g., counter-clockwise or left-handed direction) that the spool 574 is revolved 565 in and in the same direction as the spool 572 is revolved 563 in. Accordingly, the reinforcing members 431, 432, 433 may form a crossing pattern or a mesh of reinforcing members 431, 432, 433. Furthermore, the spool 576 may be revolved 567 at a speed that is faster than the speed at which the spool 574 is revolved 565, resulting in the third reinforcement member 433 comprising a spiral pitch that is lesser than the spiral pitch of the second reinforcement member 432 and an angle 453 that is greater than the angle 452 of the second reinforcement member 432. As the core 402 continues to run, the fourth coating unit 560 may be operated to form a fourth layer 437 of the same plastic material around the third plastic layer 436 and the third reinforcement member 433, covering or embedding the third reinforcement member 433 beneath the fourth plastic layer 437. Lastly, a fifth layer (e.g., an external jacket) (not shown) of a plastic material may be extruded around the fourth plastic layer 437 by the fourth coating unit 560 or a fifth coating unit (not shown), which may be located after the fourth coating unit 560.

The angles 451, 452, 453 may be selected or otherwise formed by controlling the ratio between the linear speed 514 of the core 402 and the speed of revolution 563, 565, 567 of the reinforcement members 431, 432, 433. During the slickline 552 forming operations, the winding apparatuses 562, 564, 566 may be operated to increase the speed (i.e., accelerate) or decrease the speed (i.e., decelerate) at which the corresponding spools 572, 574, 576 revolve around the core 402 to change the pitches and, thus, the angles 451, 452, 453 of the corresponding reinforcement members 431, 432, 433 with respect to the axis 416. Thus, periodically changing the speed at which the spools 572, 574, 576 revolve around the core 402 may form alternating high pitch lesser angle intervals 462 and low pitch greater angle intervals 464 of the reinforcement members 431, 432, 433, as shown in FIG. 20. However, when accelerating or decelerating the speed of the revolution 563, 565, 567 of the spools 572, 574, 576, the relative revolution 567 speed of the reinforcement member 433 with respect to the revolution 565 speed of the reinforcement member 432 may be maintained substantially unchanged (i.e., constant), and the relative revolution 567 speed of the reinforcement member 433 with respect to the revolution 563 speed of the reinforcement member 431 may also be maintained substantially unchanged.

For clarity and ease of understanding, the apparatus 550 is shown utilizing or holding just three spools 572, 574, 576 to wind three reinforcement members 431, 432, 433 around the core 402 to form the composite slickline 552. However, it is to be understood that the apparatus 550 may utilize or hold additional spools of reinforcement members 431, 432, 433 and/or comprise additional winding apparatuses to form other composite slicklines within the scope of the present disclosure. For example, the winding apparatus 562 may utilize or hold four spools 572 of reinforcement members 431, the winding apparatus 564 may utilize or hold eight spools 574 of reinforcement member 432, and the winding apparatus 566 may utilize or hold eight spools 576 of reinforcement member 433 to form the slickline 450 or the slickline 460.

Although FIG. 22 shows the reinforcement members 431, 432, 433 being wound to form the slickline 552, it is to be understood that other members, such as electrical conductors (e.g., metallic wires) and/or optical fibers 404, may be wrapped around the core 402 to form a slickline according to one or more aspects of the present disclosure. Furthermore, one or more layers of reinforcement members 431, 432, 433 may be replaced with one or more layers of optical fibers 404 operable to conduct optical signals and/or one or more electrical conductors operable to conduct electrical energy or electrical signals.

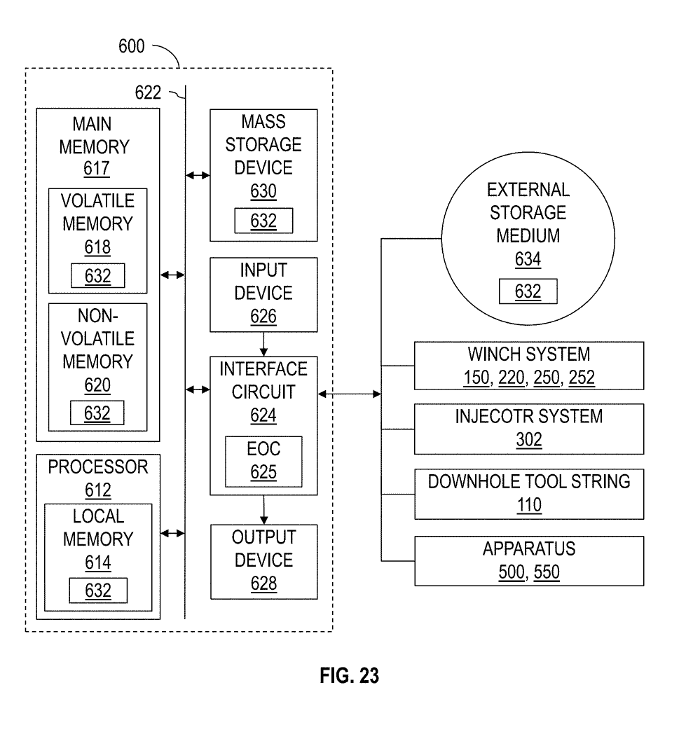

FIG. 23 is a schematic view of at least a portion of an example implementation of a processing device 600 according to one or more aspects of the present disclosure. The processing device 600 may be in communication with one or more portions of the wellsite systems 100, 300, including the conveyance systems 150, 220, 250, 252, 302, and the downhole tool string 110. The processing device 600 may be in communication with the apparatuses 500, 550. For clarity, these and other components in communication with the processing device 600 will be collectively referred to hereinafter as “sensor and actuated equipment.” The processing device 600 may be operable to receive coded instructions 642 from the human operators 164 and signals generated by the sensor equipment, process the coded instructions 642 and the signals, and communicate control signals to the actuated equipment to execute the coded instructions 642 to implement at least a portion of one or more example methods and/or operations described herein, and/or to implement at least a portion of one or more of the example systems described herein. The processing device 600 may be or form a portion of the processing device 162 and/or the control tool 112.

The processing device 600 may be or comprise, for example, one or more processors, special-purpose computing devices, servers, personal computers (e.g., desktop, laptop, and/or tablet computers) personal digital assistant (PDA) devices, smartphones, internet appliances, and/or other types of computing devices. The processing device 600 may comprise a processor 612, such as a general-purpose programmable processor. The processor 612 may comprise a local memory 614, and may execute coded instructions 642 present in the local memory 614 and/or another memory device. The processor 612 may execute, among other things, the machine-readable coded instructions 642 and/or other instructions and/or programs to implement the example methods and/or operations described herein. The programs stored in the local memory 614 may include program instructions or computer program code that, when executed by an associated processor, facilitate the wellsite systems 100, 300 and/or the apparatuses 500, 550 to perform the example methods and/or operations described herein. The processor 612 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Of course, other processors from other families are also appropriate.

The processor 612 may be in communication with a main memory 617, such as may include a volatile memory 618 and a non-volatile memory 620, perhaps via a bus 622 and/or other communication means. The volatile memory 618 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 620 may be, comprise, or be implemented by read-only memory, flash memory, and/or other types of memory devices. One or more memory controllers (not shown) may control access to the volatile memory 618 and/or non-volatile memory 620.

The processing device 600 may also comprise an interface circuit 624. The interface circuit 624 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 624 may also comprise a graphics driver card. The interface circuit 624 may also comprise a communication device, such as a modem or network interface card to facilitate exchange of data with external computing devices via a network (e.g., Ethernet connection, digital subscriber line (DSL), telephone line, coaxial cable, cellular telephone system, satellite, etc.). One or more of the actuated equipment may be connected with the processing device 600 via the interface circuit 624, such as may facilitate communication between the actuated equipment and the processing device 600.

The interface circuit 624 or another portion of the processing device 600 may comprise an electrical/optical conversion (EOC) module 625 permitting the processing device 600 to communicate with the sensor and actuated equipment via optical signals. The EOC module 625 may comprise an electrical-to-optical transducer or interface operable to convert and transmit electrical signals in the form of optical signals and an optical-to-electrical transducer or interface operable to receive and convert optical signals to electrical signals. Accordingly, the EOC module 625 may facilitate communication via optical conductors (e.g., optical fibers) communicatively connecting the processing device 600 with the sensor and actuated equipment. For example, the EOC module 625 may facilitate communication via the optical conductors of the line 120 and the conduit 122.

One or more input devices 626 may also be connected to the interface circuit 624. The input devices 626 may permit the human operators 164 to enter the coded instructions 642, such as control commands, processing routines, and input data. The input devices 626 may be, comprise, or be implemented by a keyboard, a mouse, a touchscreen, a track-pad, a trackball, an isopoint, and/or a voice recognition system, among other examples. One or more output devices 628 may also be connected to the interface circuit 624. The output devices 628 may be, comprise, or be implemented by display devices (e.g., a liquid crystal display (LCD), a light-emitting diode (LED) display, or cathode ray tube (CRT) display), printers, and/or speakers, among other examples. The processing device 600 may also communicate with one or more mass storage devices 640 and/or a removable storage medium 644, such as may be or include floppy disk drives, hard drive disks, compact disk (CD) drives, digital versatile disk (DVD) drives, and/or USB and/or other flash drives, among other examples.

The coded instructions 642 may be stored in the mass storage device 640, the main memory 617, the local memory 614, and/or the removable storage medium 644. Thus, the processing device 600 may be implemented in accordance with hardware (perhaps implemented in one or more chips including an integrated circuit, such as an ASIC), or may be implemented as software or firmware for execution by the processor 612. In the case of firmware or software, the implementation may be provided as a computer program product including a non-transitory, computer-readable medium or storage structure embodying computer program code (i.e., software or firmware) thereon for execution by the processor 612. The coded instructions 642 may include program instructions or computer program code that, when executed by the processor 612, may cause the wellsite systems 100, 300 and/or the apparatuses 500, 550 to perform intended methods, processes, and/or operations disclosed herein.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the scope of the present disclosure, and that they may make various changes, substitutions and alterations herein without departing from the spirit and scope of the present disclosure.

Generally the disclosure relates to an apparatus comprising a conveyance system operable for lowering and retrieving a downhole tool in and out of a wellbore, wherein the conveyance system comprises a drum operable for rotating and receiving a line connectable with the downhole tool; a motor-generator mechanically connected with the drum and operable for receiving electrical energy to impart torque to the drum; and receiving torque from the drum to generate electrical energy; and an energy storage electrically connected with the moto-generator and operable for storing electrical energy received from the motor-generator.

The conveyance system may be or comprise at least one of a winch system and an injector system.

The energy storage may be operable for supplying electrical energy to the motor-generator and/or for supplying electrical energy to an additional operational element, such as a slurry pump.

The motor-generator may be operable for receiving torque from the drum as the downhole tool is lowered in the wellbore; and generating electrical energy to be stored by the energy storage.

The energy storage may comprise a battery and/or an ultra-capacitor.

The line may be or comprise a slickline, a wireline, or a multiline.

The energy storage may be a source of energy for performing an additional wellsite operation, such as pumping cement.

The motor-generator may be or comprise an asynchronous or synchronous motor operable for receiving alternating current (AC) electrical energy to impart torque to the drum; and receiving torque from the drum to generate AC electrical energy; the conveyance system further comprises a controller electrically connected between the motor-generator and the energy storage; and the controller may be operable for converting AC electrical energy received from the motor-generator to DC electrical energy to be stored by the energy storage.

The motor-generator may be or comprise a shunt-wound motor or a series-wound motor operable for receiving direct current (DC) electrical energy to impart torque to the drum; and receiving torque from the drum to generate DC electrical energy; and the conveyance system may further comprise an electrical chopper electrically connected between the motor-generator and the energy storage and operable for fixing DC electrical energy provided to the energy storage from variable DC electrical energy received from the motor-generator.

The apparatus may comprise an additional source of electrical energy, wherein the conveyance system is operable for electrically connecting with the additional source of electrical energy and the energy storage to supply electrical energy to the motor-generator, and to electrically connect one of the additional source of electrical energy and the energy storage when electrical energy from the other of the additional source of electrical energy and the energy storage is not sufficient.

The conveyance system may be disposed on a vehicle, and wherein the vehicle comprises for motion a transportation source of energy and wherein the transportation source of energy is electrically connected with energy storage, and wherein the energy storage is operable for storing electrical energy from the transportation source of energy.

The motor-generator may be one of a plurality of motor-generators, each operable for receiving electrical energy to impart torque to the drum; and receiving torque from the drum to generate electrical energy.

The disclosure also relates to an apparatus comprising a conveyance system operable for lowering and retrieving a downhole tool in and out of a wellbore via a line connected with the downhole tool, wherein the conveyance system comprises a reel operable for receiving the line; and an injector head disposed between the wellhead and the reel and operable to convey the line and the downhole tool in and out of the wellbore, wherein the injector head grips the line to substantially support the tensions caused by at least the weight of the downhole tool.

The line may be or comprise a slickline, a wireline, or a multiline.

A first portion of the line extending between the tool string and the injector head may be under a first tension during lowering and retrieving of the downhole tool, wherein a portion of the line extending between the reel and the injector head is under a second tension during lowering and retrieving of the downhole tool, and wherein the second tension is independent from the first tension.

A portion of the line extending between the reel and the injector head may be substantially free of tension.

The injector head may comprise opposing circulating members operable to grip the line by compressing the line causing friction between the circulating members and the line. The circulating members may comprise belts or chains. Alternatively, each of the circulating members comprises a channel extending longitudinally along a surface of each circulating member.

The disclosure also relates to an apparatus comprising a line operable to connect a conveyance system located at a wellsite surface with a downhole tool located within a wellbore extending from the wellsite surface, wherein the line comprises a core; a plastic material covering the core; and at least a conductor wound around the core in a helical configuration and embedded within the plastic material.

The line may be or comprise a slickline, a wireline, or a multiline.

The plastic material may comprise at least a radially inner plastic layer and a radially outer plastic layer, and the conductor may be disposed between the radially inner and radially outer plastic layers.

The core may be or comprise steel and/or carbon fibers and/or an optical fiber operable to conduct optical signals and/or a metallic wire operable to conduct electrical signals.

The line may further comprise a plurality of conductors wound around the core in a helical configuration and embedded within the plastic material.

The helical configuration of the conductor may comprise a variable pitch and/or alternating intervals of greater and lesser pitch.

The apparatus further comprises a first layer of plastic material covering the core; at least a first reinforcement member wound around the first layer of plastic material in a first helical configuration; a second layer of plastic material covering the first reinforcement member and the first layer of plastic material; at least a second reinforcement member wound around the second layer of plastic material in a second helical configuration; and a third layer of plastic material covering the second reinforcement member and the second layer of plastic material, wherein the conductor is wound around one of the first or second layers of plastic material.

The disclosure also relates to a method comprising forming a line operable to connect a conveyance system located at a wellsite surface with a downhole tool located within a wellbore extending from the wellsite surface by running a core though an apparatus comprising a first coating unit, a second coating unit, and a winding apparatus disposed between the first and second coating units; operating the first coating unit to cover the core with a first layer of plastic material; operating the winding device to wind a conductor around the first layer of plastic material in a helical configuration; and operating the second coating unit to cover the first layer of plastic material and the conductor with a second layer of plastic material.

The coating unit may be or comprise at least one of an extruder, a fluidized bed, and a taping unit.

The line may be or comprise a slickline, a wireline, or a multiline.

The conductor line may be or comprise an optical fiber operable to conduct optical signals and/or a metallic wire operable to conduct electrical signals.

The conductor may be one of a plurality of conductors, wherein operating the winding device comprises winding the plurality of conductors around the first layer of plastic material in the helical configuration, and wherein operating the second coating unit comprises covering the first layer of plastic material and the plurality of conductors with the second layer of plastic material.

At least one of the plurality of conductors may be or comprise an optical fiber operable to conduct optical signals, and wherein at least one of the plurality of conductors comprises a metallic wire operable to conduct electrical signals.

The core may be or comprise carbon fibers.

Operating the winding device may further comprise alternatingly increasing and decreasing winding speed of the conductor resulting in the helical configuration of the conductor comprising alternating intervals of lesser and greater pitch.

The disclosure also relates to an apparatus comprising a line operable to connect a conveyance system located at a wellsite surface with a downhole tool located within a wellbore extending from the wellsite surface, wherein the line comprises a core; a first layer of plastic material covering the core; at least a first reinforcement member wound around the first layer of plastic material in a first helical configuration; a second layer of plastic material covering the first reinforcement member and the first layer of plastic material; at least a second reinforcement member wound around the second layer of plastic material in a second helical configuration; and a third layer of plastic material covering the second reinforcement member and the second layer of plastic material.

The first helical configuration of the first reinforcement member may comprise a first helix angle measured with respect to axis of the line, wherein the second helical configuration of the second reinforcement member comprises a second helix angle measured with respect to the axis of the line, and wherein the second helix angle is substantially greater than the first helix angle.

The first helix angle may range between about 0 degrees and about 40 degrees, and wherein the second helix angle may range between about first helix angle and about 90 degrees.

The line may be or comprise a slickline, a wireline, or a multiline.

One of the first and second helical configurations is a right-handed helix, and wherein the other of the first and second helical configurations is a left-handed helix.

The first helical configuration of the first reinforcement member may comprise a first pitch, wherein the second helical configuration of the second reinforcement member comprises a second pitch, and wherein the first pitch is substantially greater than the second pitch.

The first helical configuration of the first reinforcement member may comprise alternating intervals of greater and lesser pitch, wherein the second helical configuration of the second reinforcement member comprises alternating intervals of greater and lesser pitch, wherein the intervals of greater pitch of the first and second reinforcement members coincide, and wherein the intervals of lesser pitch of the first and second reinforcement members coincide.

The line may further comprise at least a third reinforcement member wound around the third layer of plastic material in a third helical configuration; and a fourth layer of plastic material covering the third reinforcement member and the third layer of plastic material.

The first reinforcement member may be one of a first plurality of reinforcement members wound around the first layer of plastic material in the first helical configuration, and the second reinforcement member may be one of a second plurality of reinforcement members wound around the second layer of plastic material in the second helical configuration.

The core may be or comprise steel and/or carbon fibers.

The first and second reinforcement members may also be or comprise carbon fibers.

The line further may further comprise a conductor wound around one of the first and second layers of plastic material in a helical configuration.

The conductor may be or comprise an optical fiber operable to conduct optical signals. The conductor may be or comprise a metallic wire operable to conduct electrical signals.

The disclosure also relates to a method comprising forming a line operable to connect a conveyance system located at a wellsite surface with a downhole tool located within a wellbore extending from the wellsite surface by running a core though an apparatus comprising a first coating unit; a second coating unit; a third coating unit; a first winding apparatus disposed between the first and second coating units; and a second winding apparatus disposed between the second and third coating units. The method comprises operating the first coating unit to cover the core with a first layer of plastic material; operating the first winding device to wind a first reinforcement member around the first layer of plastic material in a first helical configuration; operating the second coating unit to cover the first layer of plastic material and the first reinforcement member with a second layer of plastic material; operating the second winding device to wind a second reinforcement member around the second layer of plastic material in a second helical configuration; and operating the third coating unit to cover the second layer of plastic material and the second reinforcement member with a third layer of plastic material.

The first helical configuration of the first reinforcement member comprises a first helix angle measured with respect to axis of the line, wherein the second helical configuration of the second reinforcement member comprises a second helix angle measured with respect to the axis of the line, and wherein the second helix angle is substantially greater than the first helix angle.

The first helix angle ranges between about 0 degrees and about 40 degrees, and wherein the second helix angle ranges between about 40 degrees and about 90 degrees.

The line may be or comprise a slickline, a wireline, or a multiline.

The core may be or comprise steel and/or carbon fibers.

The first and second reinforcement members are or comprise carbon fibers.

The first reinforcement member is one of a first plurality of reinforcement members, wherein the second reinforcement member is one of a second plurality of reinforcement members, wherein operating the first winding device comprises winding the first plurality of reinforcement members around the first layer of plastic material in the first helical configuration, and wherein operating the second winding device comprises winding the second plurality of reinforcement members around the second layer of plastic material in the second helical configuration.

Operating the first winding device comprises winding the first reinforcement member around the first layer of plastic material in a first direction, and operating the second winding device comprises winding the second reinforcement member around the second layer of plastic material in a second direction that is opposite of the first direction.

Operating the first winding device further comprises winding the first reinforcement member around the first layer of plastic material at a first speed resulting in the first helical configuration comprising a first pitch, wherein operating the second winding device further comprises winding the second reinforcement member around the second layer of plastic material at a second speed resulting in the first helical configuration comprising a second pitch, and wherein the first speed is substantially lesser than the second speed resulting in the first pitch being substantially greater than the second pitch.

The apparatus further comprises a fourth coating unit; and a third winding apparatus disposed between the third and fourth coating units; and the method further comprises operating the third winding device to wind a third reinforcement member around the third layer of plastic material in a third helical configuration; and operating the fourth coating unit to cover the third layer of plastic material and the third reinforcement member with a fourth layer of plastic material, wherein the first, second, and third helical configurations each comprise a different pitch.

Operating the first winding device further comprises alternatingly increasing and decreasing winding speed of the first reinforcement member resulting in the first helical configuration of the first reinforcement member comprising alternating intervals of lesser and greater pitch, and operating the second winding device further comprises alternatingly increasing and decreasing winding speed of the second reinforcement member resulting in the second helical configuration of the second reinforcement member comprising alternating intervals of lesser and greater pitch, wherein the intervals of lesser pitch of the first and second reinforcement member coincide along axis of the line, and wherein the intervals of greater pitch of the first and second reinforcement member coincide along axis of the line.

The method further comprises winding a first conductor around the first layer of plastic material.

At least one of the first and second conductors may be or comprise an optical fiber operable to conduct optical signals and/or a metallic wire operable to conduct electrical signals.

The Abstract at the end of this disclosure is provided to permit the reader to quickly ascertain the nature of the technical disclosure. It is submitted with the understanding that it will not be used to interpret or limit the scope or meaning of the claims.

1. An apparatus comprising:
a conveyance system operable for lowering and retrieving a downhole tool in and out of a wellbore, wherein the conveyance system comprises:
a drum operable for rotating and receiving a line connectable with the downhole tool;
a motor-generator mechanically connected with the drum and operable for:
receiving electrical energy to impart torque to the drum; and
receiving torque from the drum to generate electrical energy; and
an energy storage electrically connected with the moto-generator and operable for:
storing electrical energy received from the motor-generator.

2. The apparatus of claim 1 wherein the conveyance system is or comprises at least one of a winch system and an injector system.

3. The apparatus of claim 1 wherein the energy storage is operable for supplying electrical energy to the motor-generator and/or to an additional operational element.

4. The apparatus of claim 1 wherein the motor-generator is operable for:
receiving torque from the drum as the downhole tool is lowered in the wellbore; and
generating electrical energy to be stored by the energy storage.

5. The apparatus of claim 1 comprising an additional source of electrical energy, wherein the conveyance system is operable for electrically connecting with the additional source of electrical energy and the energy storage to supply electrical energy to the motor-generator, and to electrically connect one of the additional source of electrical energy and the energy storage when electrical energy from the other of the additional source of electrical energy and the energy storage is not sufficient.

6. The apparatus of claim 1 wherein the conveyance system is disposed on a vehicle, and wherein the vehicle comprises for motion a transportation source of energy and wherein the transportation source of energy is electrically connected with energy storage, and wherein the energy storage is operable for storing electrical energy from the transportation source of energy.

7. The apparatus of claim 1 wherein the motor-generator is one of a plurality of motor-generators, each operable for:
receiving electrical energy to impart torque to the drum; and
receiving torque from the drum to generate electrical energy.

8. An apparatus comprising:
a conveyance system operable for lowering and retrieving a downhole tool in and out of a wellbore via a line connected with the downhole tool, wherein the conveyance system comprises:
a reel operable for receiving the line; and
an injector head disposed between the wellhead and the reel and operable to convey the line and the downhole tool in and out of the wellbore, wherein the injector head grips the line to substantially support the tensions caused by at least the weight of the downhole tool.

9. The apparatus of claim 8 wherein a first portion of the line extending between the tool string and the injector head is under a first tension during lowering and retrieving of the downhole tool, wherein a portion of the line extending between the reel and the injector head is under a second tension during lowering and retrieving of the downhole tool, and wherein the second tension is independent from the first tension.

10. The apparatus of claim 8 wherein a portion of the line extending between the reel and the injector head is substantially free of tension.

11. The apparatus of claim 8 wherein the injector head comprises opposing circulating members operable to grip the line by compressing the line causing friction between the circulating members and the line.

12. The apparatus of claim 11 wherein the circulating members comprise belts or chains.

13. The apparatus of claim 11 wherein each of the circulating members comprises a channel extending longitudinally along a surface of each circulating member.

14. An apparatus comprising:
a line operable to connect a conveyance system located at a wellsite surface with a downhole tool located within a wellbore extending from the wellsite surface, wherein the line comprises:
a core;
a plastic material covering the core; and
at least a conductor wound around the core in a helical configuration and embedded within the plastic material.

15. The apparatus of claim 14 wherein the plastic material comprises at least a radially inner plastic layer and a radially outer plastic layer, and wherein the conductor is disposed between the radially inner and radially outer plastic layers.

16. The apparatus of claim 14 wherein the conductor is or comprises an optical fiber operable to conduct optical signals and/or a metallic wire operable to conduct electrical signals.

17. The apparatus of claim 14 wherein the line further comprises a plurality of conductors wound around the core in a helical configuration and embedded within the plastic material.

18. The apparatus of claim 14 wherein the helical configuration of the conductor comprises a variable pitch.

19. The apparatus of claim 14 wherein the helical configuration of the conductor comprises alternating intervals of greater and lesser pitch.

20. The apparatus of claim 14 further comprising:
a first layer of plastic material covering the core;
at least a first reinforcement member wound around the first layer of plastic material in a first helical configuration;
a second layer of plastic material covering the first reinforcement member and the first layer of plastic material;
at least a second reinforcement member wound around the second layer of plastic material in a second helical configuration; and
a third layer of plastic material covering the second reinforcement member and the second layer of plastic material,
wherein the conductor is wound around one of the first or second layers of plastic material.
